(19) United States
(12) Patent Application Publication
(10) Pub. No.: US 2023/0203239 A1
(43) Pub. Date: Jun. 29, 2023

(54) Cyclic ether-anhydride photopolyaddition and uses thereof

(71) Applicants: Université de Haute-Alsace, MULHOUSE (FR); Centre National de la Recherche Scientifique, PARIS (FR)

(72) Inventors: Jacques LALEVÉE, MULHOUSE (FR); Haifaa MOKBEL, MULHOUSE (FR); Tuba KAVALLI, ILLFURTH (FR); Romain WOLF, PFASTATT (FR)

(21) Appl. No.: 17/912,549

(22) PCT Filed: Mar. 23, 2022
(86) PCT No.: PCT/EP2021/057491

§ 371 Date: Sep. 19, 2022

(30) Foreign Application Priority Data
Mar. 24, 2020 (EP) 20305315.2

(51) Int. Cl. C08G 59/42; C08G 59/24; C08G 59/40; C09J 163/00

(52) U.S. Cl. CPC C08G 59/4215; C08G 59/245; C08G 59/4064; C09J 163/00

(57) ABSTRACT

The present invention relates to compositions (self-thermally) curable on demand under the triggering action of UV-visible to near-infrared irradiation of moderate intensity, method of using same for accelerated photopolyaddition of cyclic ether-anhydride resins or dark curing of cyclic ether-anhydride resins, and articles obtained by such method. The invention also relates to a resin casting, film or coated substrate, and an adhesive layer or bonding agent, comprising a cyclic ether-anhydride resin obtained by an accelerated curing process according to the invention. The invention additionally relates to the use of a composition of the invention for increasing the delamination strength of laminated composite materials.

### FIELD OF THE INVENTION

The present invention relates to compositions (self-thermally) curable on demand under the triggering action of UV-visible to near-infrared irradiation of moderate intensity, method of using same for accelerated photopolyaddition of cyclic ether-anhydride resins or ultrafast dark curing of cyclic ether- anhydride resins, and articles obtained by such method. The invention also relates to a resin casting, film or coated substrate, and an adhesive layer or bonding agent, comprising a cyclic ether-anhydride resin obtained by an accelerated curing process according to the invention. The invention additionally relates to the use of a composition of the invention for increasing the delamination strength of laminated composite materials.

In what follows, the numbers between brackets ([ ]) refer to the List of References provided at the end of the document.

### BACKGROUND OF THE INVENTION

Epoxy resins are widely used throughout the world. Their global market volume is expected to reach 450 kilo Tons in 2021 (about 11.2 billion $). They can be used in combination with amine hardeners through the very well established epoxy-amine reaction, and they have many applications in adhesives, paints, coatings, wind energy, composites, construction, electronics, ... However, due to the somewhat toxic nature of many amines, epoxy-amine reactions have been challenged by other epoxy polymerization modes, in an attempt to substitute the amine hardeners with other less toxic hardeners.

Carboxylic anhydrides could serve as amine-substitute. However, the major drawback of epoxy-anhydride polyaddition is that it is very slow, and requires heat or catalysis. Therefore, there remains a need for the development of new systems and methods for producing epoxy-anhydride resins, and cyclic ether-anhydride resins in general, which overcome the aforementioned drawbacks.

### BRIEF DESCRIPTION OF THE DRAWINGS

FIG. 1. UV-vis diffusion of light for a polystyrene latex (112 nm of average diameter) and calculated light penetrations of selected photons.

FIG. 2. shows the real-time Fourier transformed infrared spectroscopy (RT-FTIR) monitoring of the epoxy/anhydride reaction and epoxide conversion vs time in connection with Example 2, 1.4 mm sample with 0.1% wt IR-813-p-toluenesulfonate, 2 wt% lod, in the presence of 2 wt% imidazole accelerator compound, under Laser Diode (LD@785 nm) excitation (hv (785 nm), 2.5 W / cm²).

FIG. 3. shows the comparative epoxide conversion vs time performance of (i) 0.1 wt% IR-813/2 wt% lod/2 wt% imidazole accelerator compound @785 nm (I=2.5 W/cm²) of Example 2 as compared to (ii) the photoinitiator system 1 wt% ITX/2 wt% lod used in Example 1 @450 nm (I=450 mW/cm²).

FIG. 4: shows the comparative epoxide conversion vs time performance of 0.1 wt% IR-813/2 wt% lod @785 nm (I=2.5 W/cm²) (i) with 2 wt% imidazole accelerator compound (with accelerator) and (ii) without imidazole compound accelerator.

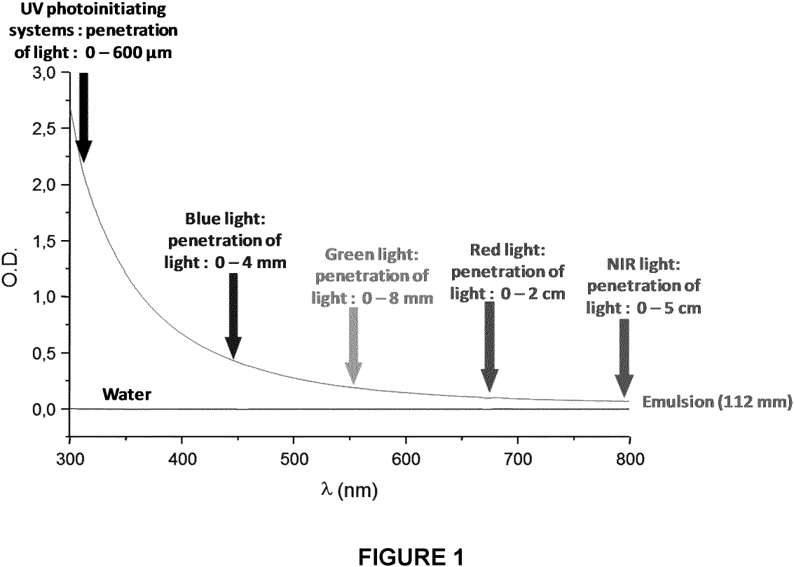

FIG. 5: shows comparative epoxide conversion vs time performance of a purely thermal initiator system (no light) vs. the photoinitiator system according to the present invention:
(i) Thermal: 52% Epox A +48% MCH anhydride at 22° C. (room temperature) vs (ii) photochemical: 52% Epox A +48% MCH anhydride +1 wt % 2-ITX +2 wt% lod (Laser diode @ 405 nm, I = 450 mW / cm²)
(iii) Thermal: 52% Epox A +48% MCH anhydride +2 wt% 1-methyl -1H-imidazole at 22° C. (room temperature) vs (iv) photochemical: 52% Epox A +48% MCH anhydride +1 wt % 2-ITX +2 wt% lod +2 wt% 1-methyl -1H-imidazole (Laser diode @ 405 nm, I = 450 mW / cm²)

FIG. 6: shows comparative epoxide conversion vs time performance of a purely thermal initiator system (no light) vs. the photoinitiator system according to the present invention:
A Thermal: 52% Epox A +48% MCH anhydride +2 wt% 1-phenylethanol at 22° C. (room temperature) vs photochemical: 52% Epox A +48% MCH anhydride +1 wt % 2-ITX +2 wt% lod +2 wt% 1-phenylethanol (Laser diode @ 405 nm, I = 450 mW / cm²)
B Thermal: 52% Epox A +48% MCH anhydride +2 wt % CARET at 22° C. (room temperature) vs photochemical: 52% Epox A +48% MCH anhydride +1 wt% 2-ITX +2 wt% lod +2 wt% CARET (Laser diode @ 405 nm, I = 450 mW / cm²)
C Thermal: 52% Epox A +48% MCH anhydride +2 wt% 4-isopropylbenzyl alcohol at 22° C. (room temperature) vs photochemical: 52% Epox A +48% MCH anhydride +1 wt% 2-ITX +2 wt% lod +2 wt% 4-isopropylbenzyl alcohol (Laser diode @ 405 nm, I = 450 mW / cm²)

FIG. 7: shows comparative epoxide conversion vs time performance of an iodonium salt as photoinitiator system vs. the photoinitiator system according to the present invention:
A: 52% Epox A +48% MCH anhydride +1 wt% 2-ITX +2 wt% lod +2 wt% 1-phenylethanol (Laser diode @ 405 nm, I = 450 mW / cm²)
B: 52% Epox A +48% MCH anhydride +1 wt% 2-ITX +2 wt% lod (Laser diode @ 405 nm, I = 450 mW / cm²)
C: 52% Epox A +48% MCH anhydride +2 wt% lod (Laser diode @ 405 nm, I = 450 mW / cm²).

FIG. 8: shows comparative epoxide conversion vs time performance of an iodonium salt as photoinitiator system vs. a photoinitiator system according to the present invention in the presence of water:
A: 52% Epox A +48% MCH anhydride +1 wt% 2-ITX +2 wt% lod (Laser diode @ 405nm, I = 450 mW / cm²)
B: 52% Epox A +48% MCH anhydride +1 wt% 2-ITX +2 wt% lod +1 wt% water (Laser diode @ 405 nm, I = 450 mW / cm²)
C: 52% Epox A +48% MCH anhydride +2 wt% lod +1 wt% water (Laser diode @ 405 nm, I = 450 mW / cm²).

FIG. 9: shows comparative epoxide conversion vs time performance of a photoinitiator system according to the present invention in the presence of oxygen (air) vs. laminate conditions (oxygen-free):
A: 52% Epox A +48% MCH anhydride +1 wt% 2-ITX +2 wt% lod under air (Laser diode @ 405 nm, I = 450 mW / cm²)
B: 52% Epox A +48% MCH anhydride +1 wt% 2-ITX +2 wt% lod under laminate conditions (Laser diode @ 405 nm, I = 450 mW / cm²).

FIG. 10: shows a dynamic mechanical analysis (DMA) (G′, G″ and tan δ) for an epoxy-anhydride photopolyaddition according to the invention (52% Epox A +48% MCH anhydride +1 wt%2-ITX+2 wt% lod, LED@405 nm: 150 mW/cm²).

FIG. 11: shows a dynamic mechanical analysis (DMA) (G′, G″ and tan δ) for an epoxy-anhydride photopolyaddition according to the invention (52% Epox A +48% MCH anhydride +1 wt%2-ITX+2 wt% lod +2 wt% 1-phenylethanol, LED@405 nm: 150 mW/cm²).

FIG. 12: shows photorheology experiments: G′ and G″ (MPa), for LED@405 nm (150 mW/cm², 100 µm samples) 52% Epox A +48% MCH anhydride +1 wt%2-ITX+2 wt% lod

FIG. 13: shows photorheology experiments: G′ and G″ (MPa), for LED@405 nm (150 mW/cm², 100 µm samples), 52% Epox A +48% MCH anhydride +1 wt%2-ITX + 2 wt% lod + 2 wt% 1-phenylethanol.

FIG. 14: shows photorheology experiments for an epoxy-anhydride polyaddition using an iodonium salt as sole photoinitiator system (no-polymerization): G′ and G″ (MPa), for LED@405 nm (150 mW/cm², 100 µm samples), 52% Epox A +48% MCH anhydride +2 wt% lod.

FIG. 15: shows the comparative epoxide conversion vs time performance of the following photoinitiating systems:
(i) 0.1 wt% IR-813/2 wt% imidazole compound accelerator
(ii) 0.1 wt% IR-813/2 wt% lod /2 wt% imidazole compound accelerator
(iii) 0.1 wt% IR-813
(iv) 0.1 wt% IR-813/2 wt% lod
in the photopolyaddition of a mixture Epox A (52%) + MCH Anhydride (48%) (Laser diode @785 nm (I=2.5 W/cm²)).

FIG. 16: shows A: an exemplary protocol and B: results, for the bonding tests discussed in Example 10.

FIG. 17: shows an exemplary protocol for preparing epoxy-anhydride resin/ multi-fiberglass sheet composites, discussed in Example 11.

FIG. 18: shows the epoxide conversion vs time performance of a mixture Epox A (52%) + MCH Anhydride (48%) + Irgacure 184 (2%) (Irradiation with Laser diode at 405 nm (I=110 mW/cm²)). Data recorded with RT-FTIR experiment, on a thick sample (1.4 mm), under air.

### DEFINITIONS

To facilitate an understanding of the present invention, a number of terms and phrases are defined below:

As used herein other than the claims, the terms “a,” “an,” “the,” and/or “said” means one or more. As used herein in the claim(s), when used in conjunction with the words “comprise,” “comprises” and/or “comprising,” the words “a,” “an,” “the,” and/or “said” may mean one or more than one. As used herein and in the claims, the terms “having,” “has,” “is,” “have,” “including,” “includes,” and/or “include” has the same meaning as “comprising,” “comprises,” and “comprise.” As used herein and in the claims “another” may mean at least a second or more.

The phrase “a mixture thereof” and such like following a listing, the use of “and/or” as part of a listing, a listing in a table, the use of “etc” as part of a listing, the phrase “such as,” and/or a listing within brackets with “e.g.,” or i.e., refers to any combination (e.g., any sub-set) of a set of listed components, and combinations and/or mixtures of related species and/or embodiments described herein though not directly placed in such a listing are also contemplated. Such related and/or like genera(s), sub-genera(s), specie(s), and/or embodiment(s) described herein are contemplated both in the form of an individual component that may be claimed, as well as a mixture and/or a combination that may be described in the claims as “at least one selected from,” “a mixture thereof” and/or “a combination thereof.”

In general, the term “substituted” whether preceded by the term “optionally” or not, and substituents contained in formulae of this invention, refer to the replacement of hydrogen radicals in a given structure with the radical of a specified substituent. When more than one position in any given structure may be substituted with more than one substituent selected from a specified group, the substituent may be either the same or different at every position. As used herein, the term “substituted” is contemplated to include all permissible substituents of organic compounds.

The term “aliphatic”, as used herein, includes both saturated and unsaturated, straight chain (i.e., unbranched) or branched aliphatic hydrocarbons, which are optionally substituted with one or more functional groups. As will be appreciated by one of ordinary skill in the art, “aliphatic” is intended herein to include, but is not limited to, alkyl, alkenyl, alkynyl moieties.

As used herein, the term “alkyl”, refers to straight and branched C1-C10alkyl groups. An analogous convention applies to other generic terms such as “alkenyl”, “alkynyl” and the like. As used herein, “lower alkyl” is used to indicate those alkyl groups (substituted, unsubstituted, branched or unbranched) having about 1-6 carbon atoms. Illustrative alkyl groups include, but are not limited to, for example, methyl, ethyl, n-propyl, isopropyl, allyl, n-butyl, sec-butyl, isobutyl, tert-butyl, n-pentyl, sec-pentyl, isopentyl, tert-pentyl, n-hexyl, sec-hexyl, moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl and the like.

The term “alicyclic”, as used herein, refers to compounds which combine the properties of aliphatic and cyclic compounds and include but are not limited to cyclic, or polycyclic aliphatic hydrocarbons and bridged cycloalkyl compounds, which are optionally substituted with one or more functional groups. As will be appreciated by one of ordinary skill in the art, “alicyclic” is intended herein to include, but is not limited to, cycloalkyl, cycloalkenyl, and cycloalkynyl moieties, which are optionally substituted with one or more functional groups. Illustrative alicyclic groups thus include, but are not limited to, for example, cyclopropyl, —CH₂—cyclopropyl, cyclobutyl, —CH₂—cyclobutyl, cyclopentyl, —CH₂—cyclopentyl—n, cyclohexyl, —CH₂—cyclohexyl, cyclohexenylethyl, cyclohexanylethyl, norborbyl moieties and the like, which again, may bear one or more substituents.

The term “heteroaliphatic”, as used herein, refers to aliphatic moieties in which one or more carbon atoms in the main chain have been substituted with a heteroatom. Thus, a heteroaliphatic group refers to an aliphatic chain which contains one or more oxygen, sulfur, nitrogen, phosphorus or silicon atoms, i.e., in place of carbon atoms. Heteroaliphatic moieties may be branched or linear unbranched. An analogous convention applies to other generic terms such as “heteroalkyl”, “heteroalkenyl”, “heteroalkynyl” and the like.

The term “heterocyclic” or “heterocycle”, as used herein, refers to compounds which combine the properties of heteroaliphatic and cyclic compounds and include but are not limited to saturated and unsaturated mono- or polycyclic heterocycles such as morpholino, pyrrolidinyl, furanyl, thiofuranyl, pyrrolyl etc., which are optionally substituted with one or more functional groups, as defined herein. In certain embodiments, the term “heterocyclic” refers to a non-aromatic 5-, 6- or 7- membered ring or a polycyclic group, including, but not limited to a bi- or tri-cyclic group comprising fused six-membered rings having between one and three heteroatoms independently selected from oxygen, sulfur and nitrogen, wherein (i) each 5-membered ring has 0 to 2 double bonds and each 6-membered ring has 0 to 2 double bonds, (ii) the nitrogen and sulfur heteroatoms may optionally be oxidized, (iii) the nitrogen heteroatom may optionally be quaternized, and (iv) any of the above heterocyclic rings may be fused to an aryl or heteroaryl ring. Representative heterocycles include, but are not limited to, pyrrolidinyl, pyrazolinyl, pyrazolidinyl, imidazolinyl, imidazolidinyl, piperidinyl, piperazinyl, oxazolidinyl, isoxazolidinyl, morpholinyl, thiazolidinyl, isothiazolidinyl, and tetrahydrofuryl.

In general, the term “aromatic” or “aryl”, as used herein, refers to stable substituted or unsubstituted unsaturated mono- or polycyclic hydrocarbon moieties having preferably 3-14 carbon atoms, comprising at least one ring satisfying Hückle’s rule for aromaticity. Examples of aromatic moieties include, but are not limited to, phenyl, indanyl, indenyl, naphthyl, phenanthryl and anthracyl.

As used herein, the term “heteroaromatic” or “heteroaryl” refers to unsaturated mono-heterocyclic or polyheterocyclic moieties having preferably 3-14 carbon atoms and at least one ring atom selected from S, O and N, comprising at least one ring satisfying the Hückel rule for aromaticity. Preferably, the heteroaromatic compound or heteroaryl may be a cyclic unsaturated radical having from about five to about ten ring atoms of which one ring atom is selected from S, O and N; zero, one or two ring atoms are additional heteroatoms independently selected from S, O and N; and the remaining ring atoms are carbon, the radical being joined to the rest of the molecule via any of the ring atoms, such as, for example, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furany1, quinolinyl, isoquinolinyl, and the like.Examples of heteroaryl moieties include, but are not limited to, pyridyl, quinolinyl, dihydroquinolinyl, isoquinolinyl, quinazolinyl, dihydroquinazolyl, and tetrahydroquinazolyl.

As used herein, the term “aralkyl” or “arylalkyl” does not deviate from the conventional meaning in the art, and refers to an aryl-substituted alkyl radical wherein the alkyl radical may be linear or branched. For example, a benzyl radical (—CH₂Ph) is an aralkyl group. Likewise, the term “heteroaralkyl” or “heteroarylalkyl” refers to an heteroaryl-substituted alkyl radical. The term “C₆₋₁₀aryl_{C1-x}alkyl”, as used herein, refers to a C6-10aryl-substituted alkyl radical wherein the alkyl radical may be linear or branched and has from one to x carbon atoms. Likewise, the term “C₆₋₁₀heteroaryl_{C1-x}alkyl”, as used herein, refers to a C6-10heteroaryl-substituted alkyl radical wherein the alkyl radical may be linear or branched and has from one to x carbon atoms.

As used herein, the term “anhydride” refers to a cyclic or acyclic carboxylic anhydride. An anhydride may have the structure R₁C(═O)—O—C(═O)R₂, wherein R₁ and R₂ independently represent C1-20alkyl, C2-20alkenyl, C2-20alkynyl, C6-10aryl, C6-10heteroaryl, or R₁ and R₂ together with the anhydride group to which they are attached form a cyclic structure.

As used herein, the term “independently” refers to the fact that the substituents, atoms or moieties to which these terms refer, are selected from the list of variables independently from each other (i.e., they may be identical or the same).

As used herein, “about” refers to any inherent measurement error or a rounding of digits for a value (e.g., a measured value, calculated value such as a ratio), and thus the term “about” may be used with any value and/or range. As used herein, the term “about” can refer to a variation of ±5% of the value specified. For example, “about 50” percent can in some embodiments carry a variation from 45 to 55 percent. For integer ranges, the term “about” can include one or two integers greater than and/or less than a recited integer. Unless indicated otherwise herein, the term “about” is intended to include values, e.g., weight %, temperatures, proximate to the recited range that are equivalent in terms of the functionality of the relevant individual ingredient, the composition, or the embodiment.

As used herein, the term “and/or” means any one of the items, any combination of the items, or all of the items with which this term is associated.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible subranges and combinations of subranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to,” “at least,” “greater than,” “less than,” “more than,” “or more,” and the like, include the number recited and such terms refer to ranges that can be subsequently broken down into subranges as discussed above. In the same manner, all ratios recited herein also include all subratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

### DETAILED DESCRIPTION OF CERTAIN PREFERRED EMBODIMENTS OF THE INVENTION

As noted above, there is a dire need for the development of new systems and methods for producing cyclic ether-anhydride resins. It has been discovered that an appropriately selected combination of a suitable photoinitiator or photosensitizer and a suitable oxidation agent can overcome the aforementioned drawbacks in the field.

In this context, there is provided herein a composition curable on demand under the triggering action of UV-visible to near-infrared irradiation comprising:
(a) at least one polyfunctional cyclic ether component comprising at least two cyclic ether moieties;
(b) at least one carboxylic anhydride component comprising at least one carboxylic anhydride moiety; and
(c) a photoinitiating system generating catalytic species comprising at least one suitable photoinitiator or photosensitizer that absorbs light at the desired UV-visible to near-infrared irradiation under which the composition is to be cured; and (i) at least one oxidation agent able to react with the photoinitiator or the photosensitizer, selected from iodonium salts, sulfonium salts, peroxides and thianthrenium salts; and/or (ii) at least one accelerator of epoxy-anhydride polyaddition processes selected from imidazoles.

As used herein, the term “polyfunctional cyclic ether” does not deviate from the conventional meaning of the term in the art, and refers to a compound comprising at least two cyclic ether moieties.

Likewise, as used herein, the term “carboxylic anhydride” does not deviate from the conventional meaning of the term in the art, and refers to a compound comprising a —C(═O)—O—C(═O)— group.

In an advantageous variant, the composition may further comprise a benzyl-type alcohol. As used herein, the term benzyl-type alcohol refers to compounds featuring an —OH group on a carbon atom α or β to an aromatic or heteroaromatic nucleus.

This new system surprisingly provides remarkable enhancement of cyclic ether-anhydride polyaddition kinetics, and leads to self-thermally curing of the composition upon UV-visible to near infrared irradiation in a very short time. The invention therefore proposes an unprecedented acceleration of 2-component cyclic ether/anhydride light-induced polymerizations (typically less than 5-10 minutes are required to obtain a functional cyclic ether-anhydride resin material). The catalytic species generated by the photoinitiating system may be strong acidic species (for example when iodonium salts are used as oxidation agent), or cationic species (for example when peroxides or onium (e.g. iodonium) salts are used as oxidation agent). For the use of imidazoles as accelerators, anionic species initiate the opening of the anhydride for an efficient epoxy/anhydride polyaddition.

Advantageously, the irradiation intensity may be moderate. For example, the intensity may be as low as 25 mW/cm² or even lower (for example 25 mW/cm² ≤ I ≤ 100 W/cm², preferably 25 mW/cm² ≤ I ≤ 20 W/cm²).

### Polyfunctional Cyclic Ether Component

Advantageously, the polyfunctional cyclic ether component in the curable compositions according to the invention may be any suitable compound containing at least two cyclic ether moieties. The polyfunctional cyclic ether components used in the composition can be used alone or in admixture, and they advantageously have a number of epoxide functions greater than or equal to two, preferably two to four. One can refer to the various publications in the literature that describe the chemistry, structure, reactivity of epoxide monomers, such as notably: “Handbook of Epoxy Resins,” Lee & Neville, Mc Graw-Hill (1982), “Chemistry and technology of the epoxy Resins,” B. Ellis, Chapman Hall (1993), New York and “Epoxy Resins Chemistry and technology,” C. A. May, Marcel Dekker, New York (1988). [1] Advantageously, the polyfunctional cyclic ether component may contain 2, 3 or 4, preferably 2 or 3, cyclic ether moieties. The cyclic ether moieties of the polyfunctional cyclic ether component may each independently be reactive to carboxylic anhydride compounds (polyaddition reaction). Aromatic, cycloaliphatic, heterocyclic or aliphatic polyfunctional cyclic ether components can be used indiscriminately in the context of the invention. The polyfunctional cyclic ether components can carry substituents such as aliphatic, cycloaliphatic, aromatic or heterocyclic chains, or other elements such as fluorine and bromine for example. Generally, the substituents present on the polyfunctional cyclic ether component is not of a nature to interfere with the reaction of the cyclic ether functions with an anhydride group. Such additional types of substituents include halogens; hydroxyl, sulfhydryl, cyano, nitro, silicon, for example. Typically, primary or secondary amine substituents will be avoided, as these may interfere with the epoxy-anhydride polyaddition (competition of the epoxy-amine polyaddition).

For example, the cyclic ether functional group may be a 3- to 6-membered cyclic ether functional group, preferably a 3- or -membered cyclic ether functional group. For example, the cyclic ether functional group may be an epoxy or an oxetane group, preferably an epoxy functional group.

Advantageously, at least one polyfunctional cyclic ether component may be selected from aliphatic, heteroaliphatic, aromatic or heteroaromatic polyfunctional epoxy compounds. For example, polyfunctional aromatic epoxy compounds such as:

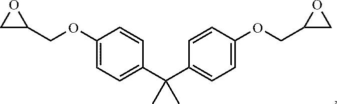

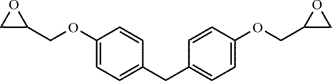 [SMILES: c1cc(OCC2CO2)ccc1Cc1ccc(OCC2CO2)cc1]

or

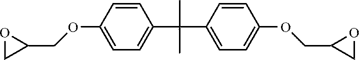 [SMILES: CC(C)(c1ccc(OCC2CO2)cc1)c1ccc(OCC2CO2)cc1]

may be used.

Polyfunctional heteroaliphatic epoxy compounds may be used, such as:

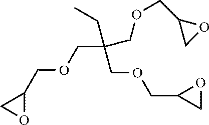 [SMILES: CCC(COCC1CO1)(COCC1CO1)COCC1CO1]

or

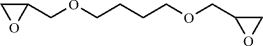 [SMILES: C(CCOCC1CO1)COCC1CO1]

Epoxy prepolymers may also be used as polyfunctional cyclic ether components, in particular those epoxy prepolymers obtained from reaction of diols with epichlorhydrine, such as bisphenol A diglycidyl ether, 1,4-butanediol diglycidyl ether.

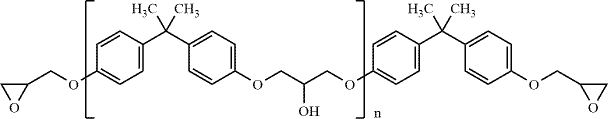

### Poly(bisphenol A-co-epichlorhydrin), Glycidyl End-Capped

Epoxy prepolymers obtained from reaction of diamines with epichlorhydrine may also be used, for example 4,4′-diaminodiphenyl methane tetraglycidyl ether.

Mixtures of two or more polyfunctional epoxy components, such as Epoxy MixA or Epoxy MixB (a mixture of Poly(bisphenol A-co-epichlorhydrin), glycidyl end-capped and 1,4-butanediol diglycidyl ether), may also be used. Epoxy MixA is composed of A + B +C below:

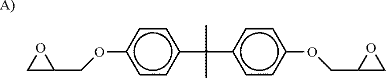

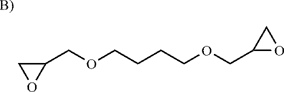

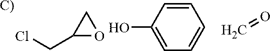

C being the oligomeric reaction products of formaldehyde with 1-chloro-2,3-epoxypropane and phenol.

As mentioned previously, the polyfunctional cyclic ether component may be used alone, or in admixture. As such, a mixture of two or more of the above-mentioned polyfunctional cyclic ether components, for example a mixture of two or more polyfunctional epoxy components, may be used.

### Carboxylic Anhydride Component

In general terms, any organic compound comprising a carboxylic anhydride group may be suitable to go into the composition. A mixture of two or more anhydride-containing components can be used. The carboxylic anhydride component can be selected from heteroaliphatic, aromatic or heteroaromatic compounds comprising at least one —C(═O)—O—C(═O)— group.

Advantageously, the carboxylic anhydride component can be selected from heteroaliphatic, aromatic or heteroaromatic compounds comprising at least one —C(═O)—O—C(═O)— group, provided it is not dodecenylsuccinic anhydride (3-(2-Dodecylen-1-yl)-dihydro-2,5-furandione, CAS 25377-73-5).

Suitable anhydrides include:
(iso)phthalic-type anhydrides such as

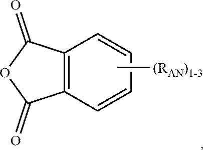

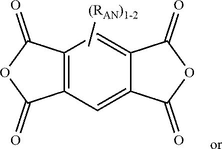

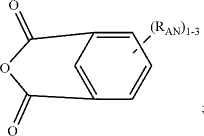

wherein each occurrence of R_{AN} independently represents H, halogen or C1-6alkyl; preferably H or C1-6alkyl; for example H, methyl or ethyl;
polyhydrophthalic-type anhydrides such as

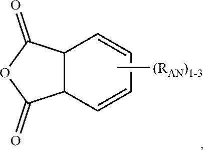

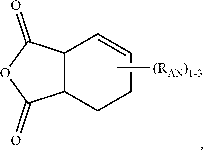

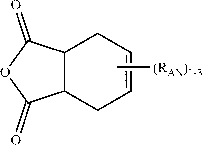

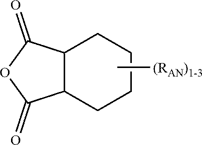

or

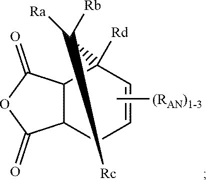

wherein each occurrence of R_{AN} independently represents H, halogen or C1-6alkyl; preferably H or C1-6alkyl; for example H, methyl or ethyl; and Ra, Rb, Rc and Rd independently represent H or halogen, for example H or Cl;
Maleic or succinic-type anhydrides such as

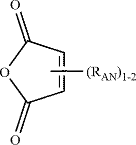

or

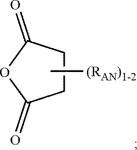

wherein each occurrence of R_{AN} independently represents H, halogen or linear or branched C1-20alkyl; for example H, chloro, methyl, ethyl, n-butyl, n-octadecyl or n-dodecyl;
aliphatic-type polyanhydrides such as

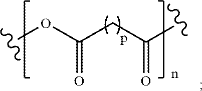

wherein p is an interger from 2 to 6, and n represents the number of monomer units in the polymer. For example, n may range from 10 to 100.

Advantageously, the carboxylic anhydride component in the curable compositions according to the invention may be a cyclic heteroaliphatic compound having the structure:

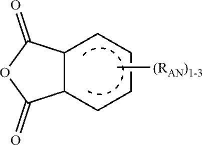

wherein the 6-membered ring may be saturated, partially unsaturated (1 or 2 double bonds) or fully unsaturated (aromatic), and each occurrence of R_{AN} independently represents H, —CO₂H or C1-6alkyl; for example H, methyl, ethyl, propyl, butyl or —CO₂H. The structure above encompasses the following sub-structures:

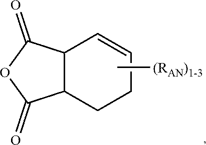

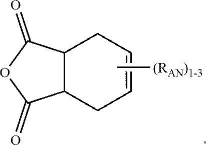

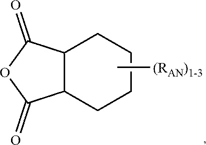

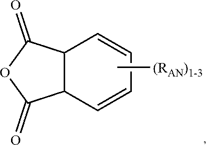

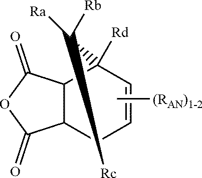

and

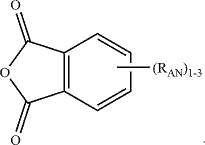

Advantageously, the anhydride component of the curable composition according to the invention may have the structure:

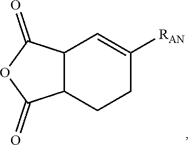

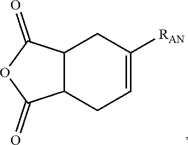

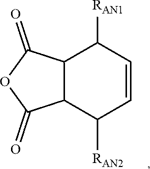

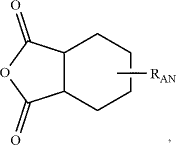

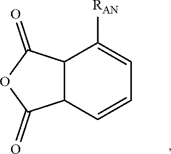

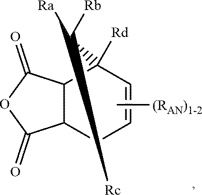

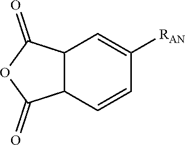

or

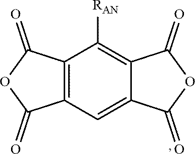

wherein each occurrence of R_{AN}, R_{AN1} and R_{AN2} independently represents H, —CO₂H or C1-6alkyl; for example H, methyl, ethyl, propyl, butyl or —CO₂H, and Ra, Rb, Rc and Rd independently represent H or halogen, for example H or Cl.

Advantageously, the anhydride component of the curable composition according to the invention may have the structure:

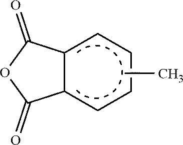

, preferably

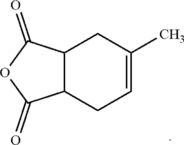

Advantageously, the carboxylic anhydride component in the curable compositions according to the invention may be a cyclic heteroaliphatic compound having the structure:

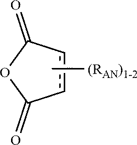

wherein the dashed bond represents a single or double bond, and each occurrence of R_{AN} independently represents H, halogen or C1-20alkyl; preferably H, halogen or C10-20alkyl; for example H, Cl, dodecyl or octadecyl.

Advantageously, the anhydride component of the curable composition according to the invention may have the structure:

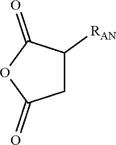

or

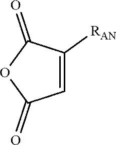

wherein each occurrence of R_{AN} independently represents H, halogen or C1-20alkyl; preferably H, halogen or C10-20alkyl; for example H, Cl, dodecyl or octadecyl.

The carboxylic anhydride components can carry other substituents in addition to those previously cited such as aliphatic, cycloaliphatic, aromatic or heterocyclic chains, or other elements such as fluorine and bromine for example. Generally, the substituents present on the anhydride component is not of a nature to interfere with the epoxy-anhydride polyaddition reaction: the substituents may be unreactive towards cyclic ether groups or may have a substantially lesser reactivity towards cyclic ether groups than the anhydride functions present on the anhydride component. Such additional types of substituents include halogens, hydroxyl, sulfhydryl, cyano, nitro, silicon, for example. Typically, primary and secondary amine substituents will be avoided as they may interfere with the epoxy-anhydride polyaddition (competition of the epoxy-amine polyaddition).

For example, anhydride components suitable in the context of the invention may be selected from any one or more from Table 1:

TABLE 1

| | | |
|---|---|---|
| 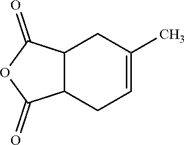 | 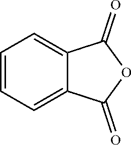 [SMILES: O=C1OC(=O)c2ccccc21] | 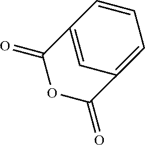 [SMILES: O=C1OC(=O)c2cccc1c2] |
| 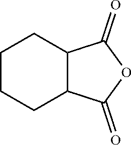 [SMILES: O=C1OC(=O)C2CCCCC12] | 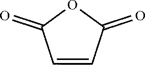 | 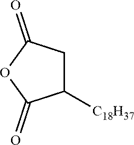 |
| 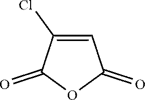 | 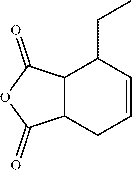 | 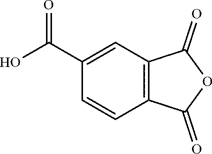 [SMILES: O=C(O)c1ccc2c(c1)C(=O)OC2=O] |
| 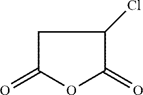 | 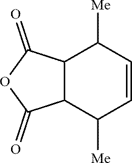 [SMILES: CC1C=CC(C)C2C(=O)OC(=O)C12] | 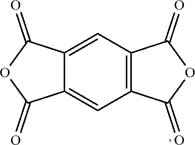 |
| 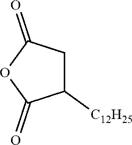 | 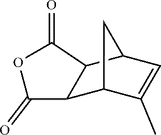 | 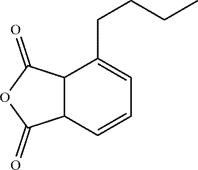 |
| 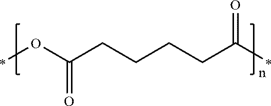 | 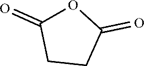 | 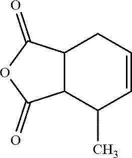 |

The carboxylic anhydride components used in the composition can be used alone or in admixture. The polyfunctional cyclic ether component and anhydride component may be used in a stoichiometric ratio (anhydride groups and epoxy groups may be in stoichiometric amount 1:1). Alternatively, the anhydride component may be used in molar excess with respect to polyfunctional cyclic ether component, to drive the polyaddition reaction to completion.

Advantageously, the carboxylic anhydride component may be used in stoichiometric excess (the number of reactive anhydride groups is preferably higher than the number of reactive cyclic ether functions, to drive the polyaddition reaction to completion. For example, the molar ratio anhydride groups: epoxy groups may range from 1.05:1 to 1.3:1).

### Photoinitiator or Photosensitizer

Advantageously, the photoinitiator or photosensitizer may be any suitable compound that absorbs light at the desired UV-visible to near-infrared irradiation under which the composition is to be cured.

The photoinitiator or photosensitizer is preferably soluble in the polyfunctional cyclic ether component and/or in the anhydride component.

Suitable photoinitiators or photosensitizers in the UV, near-UV and Visible include:
type I photoinitiators such as 2-hydroxy-2-methyl-1-phenylpropan-1-one, 2-hydroxy-1,2-diphenhylethanone, (diphenylphosphoryl)(phenyl)methanone, 2-dimethylamino)-1-(4-morpholinophenyl)ethanone, bis-acylphosphine oxide (BAPO), (diphenylphosphoryl)(mesityl)methanone (Irgacure® TPO), ethyl (2,4,6-trimethylbenzoyl) phenyl phosphinate (TPO-L®), bis(η5-2,4-cylcopentadien-1-yl)-bis(2,6-difluoro-3-(1H-pyrrol-1-yl)-phenyl) titanium (Irgacure® 784), 2,2-dimethoxy-1,2-diphenylethan-1-one (Irgacure® 651), 2-methyl-4′-(methylthio)-2-morpholinopropiophenone (Irgacure® 907);
   o type II photoinitiators such as benzophenone, xanthones, thioxanthones such as ITX, 2-ITX and CPTX, quinones, anthraquinones, and camphorquinone; 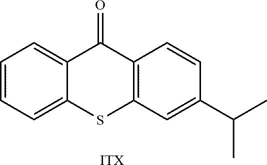 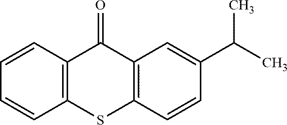 [SMILES: CC(C)c1ccc2sc3ccccc3c(=O)c2c1] 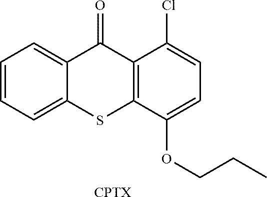
   o organic dye photosensitizers such as eosin Y and Rose Bengal; 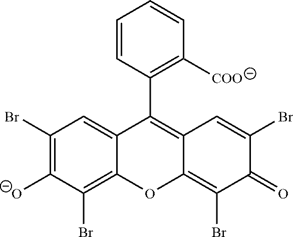 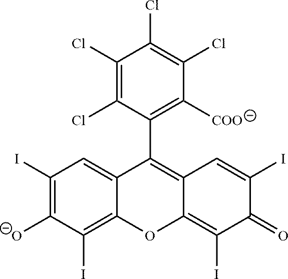
   o polyaromatic hydrocarbon photosensitizers such as pyrene and anthracene; preferably camphorquinone or thioxanthone compounds such as ITX, 2-ITX and CPTX.

Suitable photoinitiators or photosensitizers in the red to near infrared include dyes that generate heat when exposed to a 625-2500 nm light source, for example when exposed to a 625-1500 nm light irradiation.

Advantageously, the heat-generating dye may be any suitable dye that generates heat when exposed to a 625-2500 nm light source (i.e., when exposed to irradiation in the red to near-infrared), for example when exposed to a 625-1500 nm light irradiation. Advantageously, the irradiation intensity may be adjusted/tuned down so as to keep the heat generated by the NIR dye at a level below that which is sufficient to accelerate the cyclic ether/anhydride polyaddition on its own (i.e., without the oxidation agent such as iodonium salts, sulfonium salts, peroxides and thianthrenium salts). For example, the intensity may be as low as 25 mW/cm² or even lower (for example 25 mW/cm² ≤ I ≤ 100 W/cm², preferably 25 mW/cm² ≤ I ≤ 20 W/cm²).

Advantageously, the heat-generating dye may comprise a cyclic or acyclic conjugated system containing 2 or 4 heteroatoms selected from N or S the lone pair of which may participate in the conjugated system; wherein the heat-generating dye generates heat when exposed to a 625-2500 nm light source, for example when exposed to a 625-1500 nm light irradiation. Advantageously, the heat-generating dye may comprise:
an opened conjugated system containing two N or S atoms, preferably two N atoms, the lone pairs of which may participate in the conjugated system;
a conjugated macrocyclic system containing four N or S atoms, preferably four N atoms, complexed to a single metal atom; preferably a metal atom that absorbs in the red to near-infrared region of 625-2500 nm, for example a metal atom that absorbs in the range 625-1500 nm;
a metal complex comprising two bidentate conjugated ligands; each bidentate ligand containing two N or S atoms, preferably two S atoms, complexed to a single metal atom; preferably a metal atom that absorbs in the red to near-infrared region of 625-2500 nm, for example a metal atom that absorbs in the range 625-1500 nm.

For example, a heat-generating dye selected from any one or more of the following may be used:
(i) cyanine dyes;
(ii) squaraine and squarylium dyes;
(iii) push-pull compounds;
(iv) BODIPY and pyrromethene dyes;
(v) Dithiolene metal salt dyes;
(vi) Porphyrin dyes;
(vii) Copper complex dyes;
(viii) Phthalocyanine dyes;
or a mixture of one or more of the above.

The dyes may be tested for their ability to generate heat upon red-NIR irradiation by thermal imaging. For this characterization, an appropriate concentration of red-NIR dye is incorporated in the polymerizable resin and irradiated with the red-NIR light. Through thermal imaging experiments, the temperature of the resin can be recorded for different irradiation times. Thermal camera, thermocouple or pyrometer can also be used to record the temperature. Without the presence of the red-NIR-dye the temperature remains almost unchanged showing the role of the red-NIR dye as heater.

As used herein, the term “cyanine dye” does not deviate from the conventional meaning of the term in the art, and refers to a dye having an opened conjugated system where a moiety

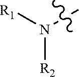

and a moiety

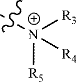

are covalently linked via a conjugated system of two or more double bonds, some of which may belong to an aromatic radical. A counter-ion X⁻ is typically present to counterbalance the positive charge of the ammonium ion. Advantageously, X⁻ may represent Cl⁻, I⁻, ClO₄⁻, p-toluenesulfonate, p-dodecylbenzenesulfonate, or a borate anion, such as triphenylbutylborate. Advantageously, the counter ion X⁻ may represent a borate anion. For example X⁻ may represent triphenylbutylborate.

The expression “opened conjugated system” refers to the fact that the moieties

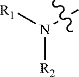

and

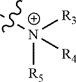

do not form a cycle together with the conjugated double bonds (i.e, the whole does not piggy-back together to form a cycle). However, the whole system may comprise one or more mono- or polycyclic alicyclic, heterocyclic, aromatic or heteroaromatic radicals. For example, cyanine dyes useable in the context of the invention include as synthetic dyes with the general formula R₂N[CH═CH]ₙCH═N⁺R₂ or R₂N⁺═CH[CH═CH]ₙNR₂ (n is a small number, typically 2-5) in which the nitrogen and part of the conjugated chain usually form part of a heterocyclic system, such as imidazole, pyridine, pyrrole, quinoline and thiazole, e.g. [2]

As used herein, the term “squaraine dye” does not deviate from the conventional meaning of the term in the art, and refers to a family of chromophores containing structures such as cyanine dyes, two donor groups conjugated to an electron deficient oxocyclobutenolate core, leading to a highly electron delocalized structure that can be exemplified as zwitterions. Generally, squaraine dyes with donor-acceptor-donor (D-A-D) structures are synthesized by the condensation reaction of 3,4-dihydroxy-3-cyclobutene-1,2- dione (squaric acid) with activated aromatic or heterocyclic components [3]

As used herein, the term “push-pull dye” does not deviate from the conventional meaning of the term in the art, and refers to organic pi-systems end -capped with an electron donor (D) and an electron acceptor (A) at each side of the pi-system. Interaction between A and D allows intramolecular charge-transfer (ICT) and a new low-energy molecular orbital is formed. Thus, it is easier to achieve excitation of electrons in the molecular orbital at longer wavelength. Typical electron donors D are represented by the substituents with +M/+I effects such as OH, NH₂, OR and NR₂, heterocyclic moieties... On the other hand, the most used electron acceptors A involve substituents featuring M/I effects such as NO₂, CN, CHO, electron deficient heterocyclic compounds... [4]

As used herein, the term “BODIPY” does not deviate from the conventional meaning of the term in the art, and refers to boron-dipyrromethene type compounds, which is a class of fluorescent dyes. It is composed of dipyrromethene complexed with a disubstituted boron atom, typically a BF2 unit. [5]

As used herein, the term “dithiolene dye” does not deviate from the conventional meaning of the term in the art, and refers to metal complexes including unsaturated bidentate ligands containing two sulfur donor atoms (e.g., dithiolene ligands attached to a central metal). They may be also referred to as “metallodithiolene dyes”. Generally, the metal used is nickel, palladium or platinum and is in a zerovalent state. Dithiolene ligands are unsaturated bidentate ligand wherein the two donor atoms are sulfur. This formed square planar complexes. Because of the extensive electron delocalization about the dithiolene ring system and the interaction of this delocalized system’s available d-orbitals on the central metal, strong NIR absorption is observed with these compounds. [6]

Advantageously, a dithiolene dye useable as heat-generator according to the present invention include:

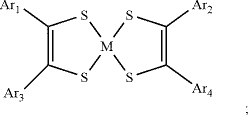

wherein M represents a metal center that absorbs in the red to near-infrared region of 625-2500 nm, for example a metal atom that absorbs in the range 625-1500 nm, such as Ni; and Ar₁, Ar₂, Ar₃, and Ar₄ independently represent a C₆₋₁₀ aryl; wherein each aryl moiety may be, individually, further substituted with one or more substituents, such as —OH, -OR, halogen atom, —NO₂, —CN, —NR^{A}₁R^{A}₂, —NHC(═O)R^{A}₃, —OC(═O)R^{A}₃, vinyl, or linear or branched C₁₋₁₀ alkyl or C₆₋₁₀ aryl moieties; wherein R and R^{A}₃ independently represent a linear or branched C₁₋₁₀ alkyl or C₆₋₁₀ aryl moiety; and R^{A}₁ and R^{A}₂ independently represent H or linear or branched C₁₋₆ alkyl or C₆₋₁₀ aryl moieties, where R^{A}₁ and R^{A}₂, taken together with the nitrogen atom to which they are attached, may form a 5- or 6-membered heterocyclic moiety; wherein each of the foregoing aryl moieties may be, individually, further substituted with one or more linear or branched C₁₋₆ alkyl or C₆₋ ₁₀ aryl moieties. Advantageously, Ar₁, Ar₂, Ar₃, and Ar₄ may independently represent a phenyl moiety; wherein each phenyl moiety may be, individually, further substituted with one or more substituents, such as those as described immediately above, preferably linear or branched C₁₋₆alkyl moieties, including methyl, propyl, butyl, i-propyl.

As used herein, the term “porphyrin dye” does not deviate from the conventional meaning of the term in the art, and refers to conjugated heterocyclic macrocycle metal complexes comprising four modified pyrrole subunits interconnected at their α carbon atoms via methine bridges (═CH—).

Advantageously, a porphyrin dye useable as heat-generator according to the present invention may have a heterocyclic conjugated system having the structure:

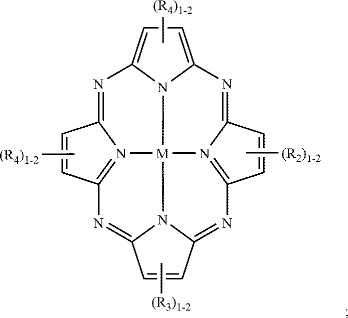

wherein M represents a metal center that absorbs in the red to near-infrared region of 625-2500 nm, for example a metal atom that absorbs in the range 625-1500 nm, such as Mg or Cu; and each occurrence of R₁, R₂, R₃, and R₄ may independently represent H, —C(═O)OR₅, vinyl, a linear or branched C₁₋₁₀alkyl or a C₆₋₁₀aryl moiety;
wherein R₅, for each occurrence, may independently represent H or an alkali metal cation such as Na⁺; and wherein each of the foregoing alkyl or aryl moieties may be, individually, further substituted with one or more linear or branched C₁₋₆ alkyl or C₆₋₁₀ aryl moieties.

As used herein, the term “copper complex dye” does not deviate from the conventional meaning of the term in the art, and refers to conjugated oxygen-containing systems (acetylacetonate derivatives) comprising either one of the following basic motifs:

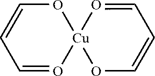

or

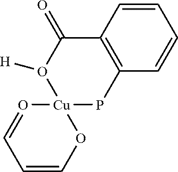

each of which may bear one or more alkyl and/or aryl substituents.

As used herein, the term “phthalocyanine dye” does not deviate from the conventional meaning of the term in the art, and refers to conjugated macrocycles which, depending on how they were synthesized, contain different metal or metalloid inclusions. Advantageously, a phthalocyanine dye useable as heat-generator may have a cyclic conjugated system having the structure:

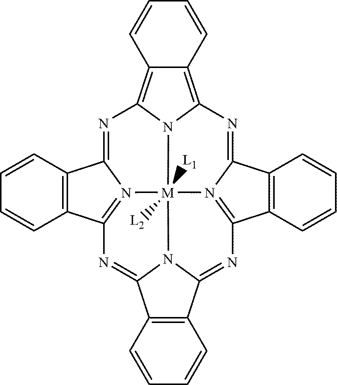

wherein M represents a metal center, for example Mn, and L₁ and L₂ independently represent acyloyl ligands or may be absent, depending on the metal atom valency.

For example, any one or more of the following may be used:

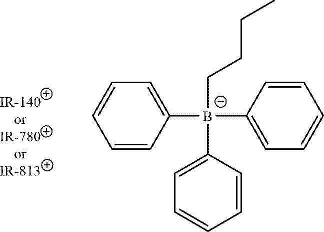

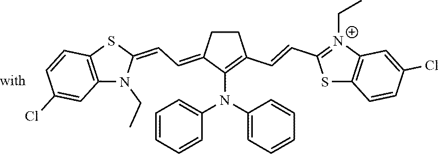

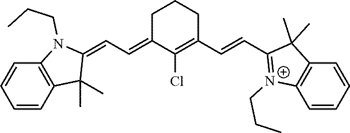 [SMILES: CCCN1/C(=C/C=C2\CCCC(/C=C/C3=[N+](CCC)c4ccccc4C3(C)C)=C2Cl)C(C)(C)c2ccccc21]

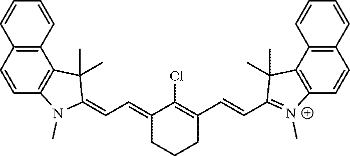 [SMILES: CN1/C(=C/C=C2\CCCC(/C=C/C3=[N+](C)c4ccc5ccccc5c4C3(C)C)=C2Cl)C(C)(C)c2c1ccc1ccccc21]

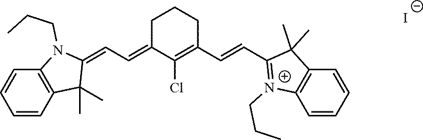 [SMILES: CCCN1/C(=C/C=C2\CCCC(/C=C/C3=[N+](CCC)c4ccccc4C3(C)C)=C2Cl)C(C)(C)c2ccccc21 ; [I-]]

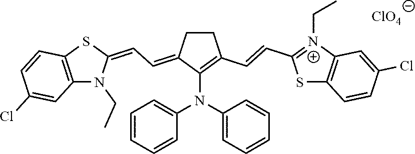

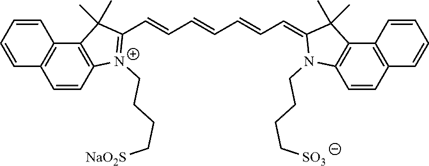

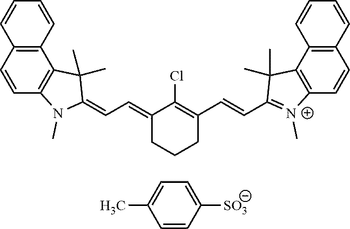

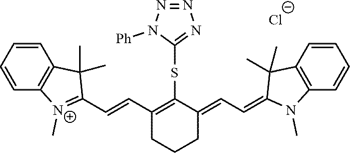 [SMILES: CN1/C(=C/C=C2\CCCC(/C=C/C3=[N+](C)c4ccccc4C3(C)C)=C2Sc2nnnn2-c2ccccc2)C(C)(C)c2ccccc21 ; [Cl-]]

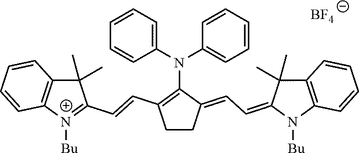

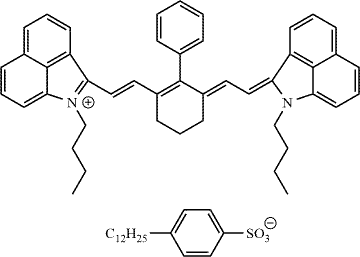

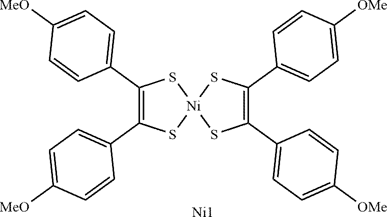

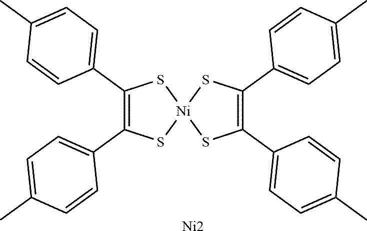

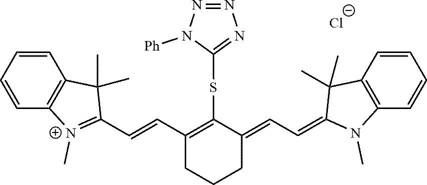 [SMILES: CN1/C(=C/C=C2\CCCC(/C=C/C3=[N+](C)c4ccccc4C3(C)C)=C2Sc2nnnn2-c2ccccc2)C(C)(C)c2ccccc21 ; [Cl-]]

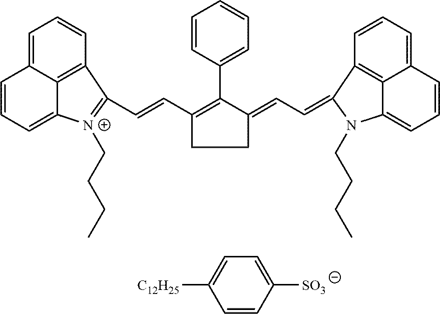

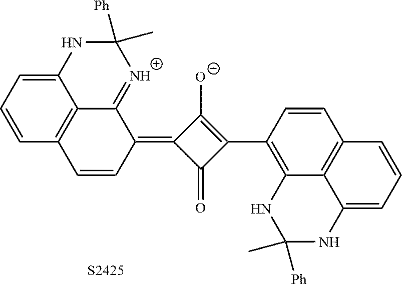

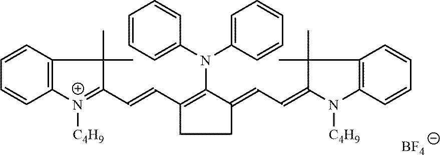

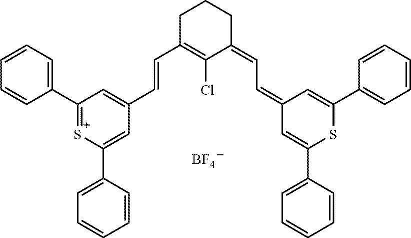 [SMILES: ClC1=C(/C=C/c2cc(-c3ccccc3)[s+]c(-c3ccccc3)c2)CCC/C1=C/C=C1C=C(c2ccccc2)SC(c2ccccc2)=C1 ; "BF4"]

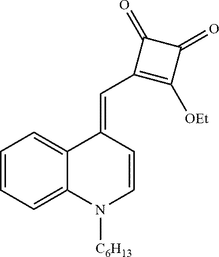

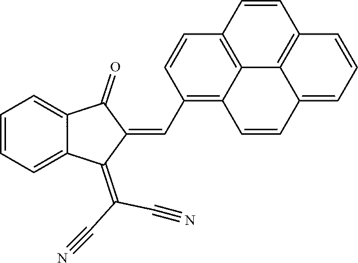 [SMILES: N#CC(C#N)=C1/C(=C/c2ccc3ccc4cccc5ccc2c3c45)C(=O)c2ccccc21]

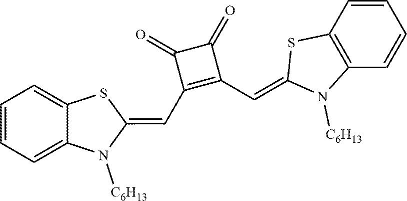

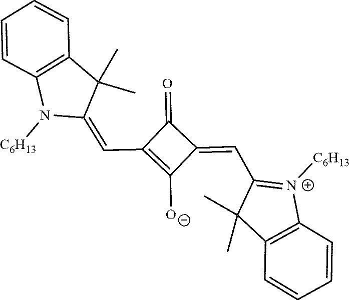

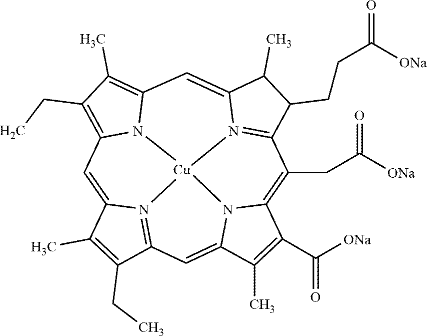

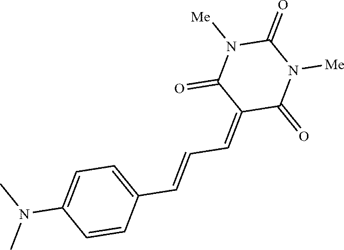 [SMILES: CN1C(=O)C(=C/C=C/c2ccc(N(C)C)cc2)C(=O)N(C)C1=O]

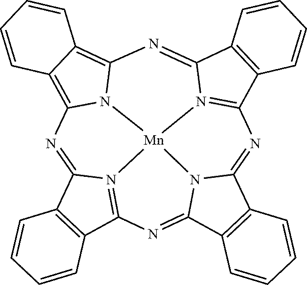

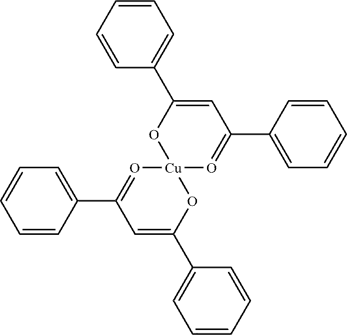

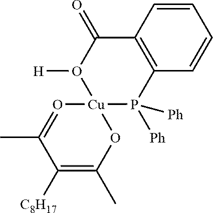

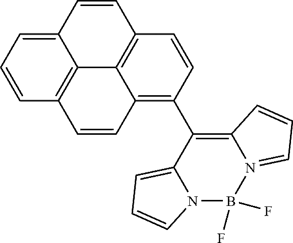

In a variant, preferred photoinitiators or photosensitizers may be those that absorb in the UV-visible range, notably between 200 and 1600 nm. As such, type I photoinitiators, type II photoinitiators, organic dye photosensitizers such as eosin Y and Rose Bengal; and polyaromatic hydrocarbon photosensitizers such as pyrene and anthracene may be preferred. Most preferably, camphorquinone or thioxanthone compounds such as ITX, 2-ITX and CPTX may be used. Advantageously, the UV-visible photoinitiator or photosensitizer may be used in 0.1-4 wt%, preferably 0.1-3 wt%, preferably 0.5-3 wt%, most preferably ≤2.5 wt% based on the total weight of the polyfunctional cyclic ether component(s) + anhydride component(s).

In another variant, preferred photoinitiators or photosensitizers may be those that absorb in the red to near-infrared range, notably in the red to near-infrared region of 625-2500 nm, for example in the range 625-1500 nm. As such, cyanine dyes may be preferred. For example, any one or more of the following may be used:

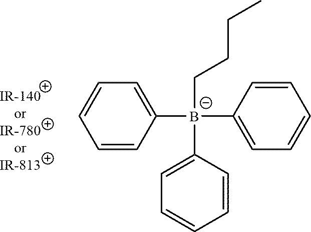

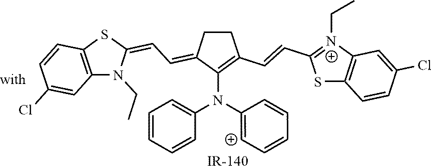

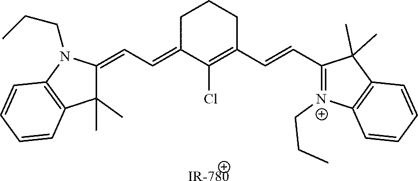

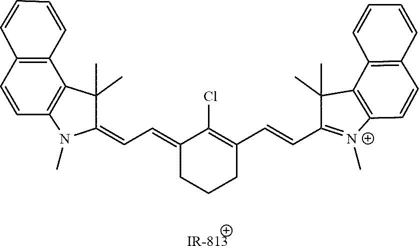

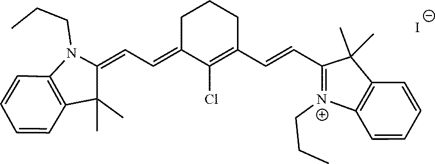 [SMILES: CCCN1/C(=C/C=C2\CCCC(/C=C/C3=[N+](CCC)c4ccccc4C3(C)C)=C2Cl)C(C)(C)c2ccccc21 ; [I-]]

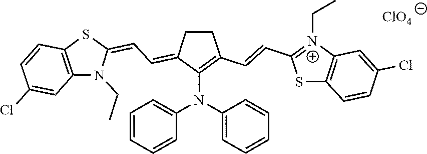

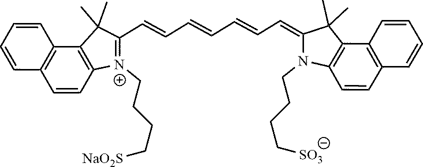

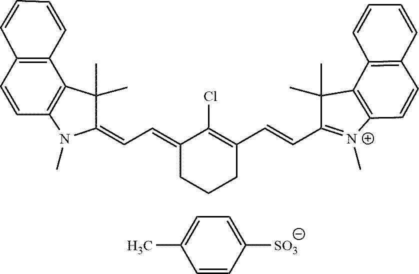

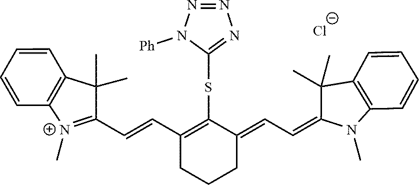 [SMILES: CN1/C(=C/C=C2\CCCC(/C=C/C3=[N+](C)c4ccccc4C3(C)C)=C2Sc2nnnn2-c2ccccc2)C(C)(C)c2ccccc21 ; [Cl-]]

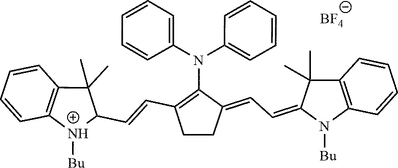

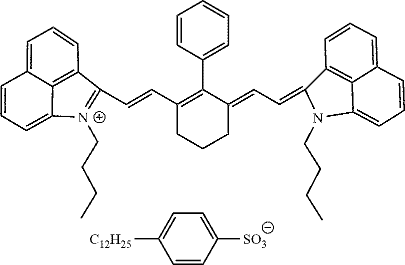

preferably IR-813.

Advantageously, the NIR photoinitiator or photosensitizer may be used in 0.05-0.5 wt%, preferably 0.1-0.4 wt%, preferably 0.1-0.3 wt%, most preferably ≤0.25 wt% based on the total weight of the polyfunctional cyclic ether component(s) + anhydride component(s).

### Oxidation Agent

Advantageously, the at least one oxidation agent may be selected from any suitable oxidation agent known in the art. For example, mention may be made of onium salts, in particular iodonium salts of formula ((R_{A})₂I⁺X_{A}⁻, or sulfonium or thianthrenium salts of formula (R_{B})₃S⁺ X_{A}⁻; wherein each occurrence of R_{A} and R_{B} independently represents a C₆₋₁₀ aryl or a C₁₋₁₀ alkyl moiety; wherein the aryl moiety may be, individually, further substituted with one or more linear or branched C₁₋₆ alkyl, —OC₁₋₆ alkyl, —SC₁₋₆ alkyl moieties, or C₆₋₁₀ aryl, —OC₆₋₁₀ aryl, —SC₆₋₁₀ aryl, —C(═O)C₆₋₁₀ aryl moieties; wherein two adjacent radicals R_{B} together with the S atom to which they are attached may form a 6-membered heterocyclic moiety; and wherein X_{A}⁻ represents a suitable counter ion such as B(PhF₆)₄⁻, AsF₆⁻ ; PF₆⁻, SbF₆⁻ or Cl⁻. Preferably iodonium salts or thianthrenium salts, as defined above, may be used. The following iodonium salts and thianthrenium salts are particularly preferred:

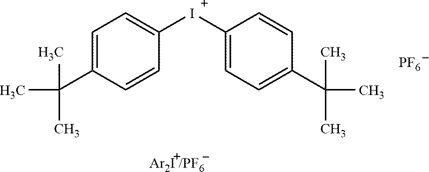

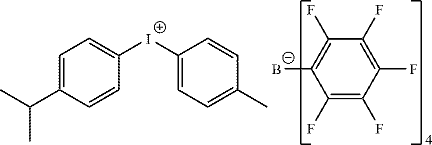

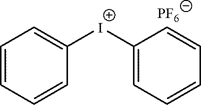

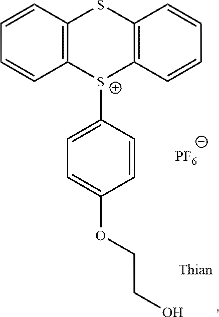

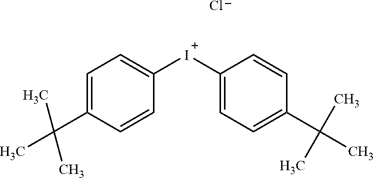 [SMILES: [Cl-] ; CC(C)(C)c1ccc([I+]c2ccc(C(C)(C)C)cc2)cc1]

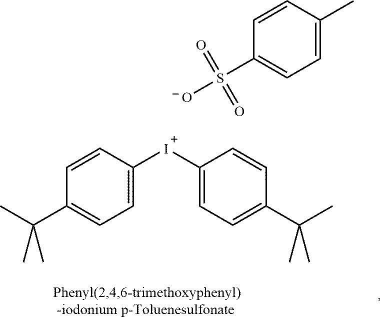

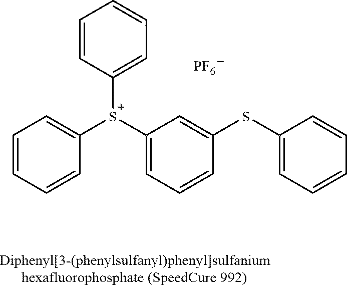

or a mixture:

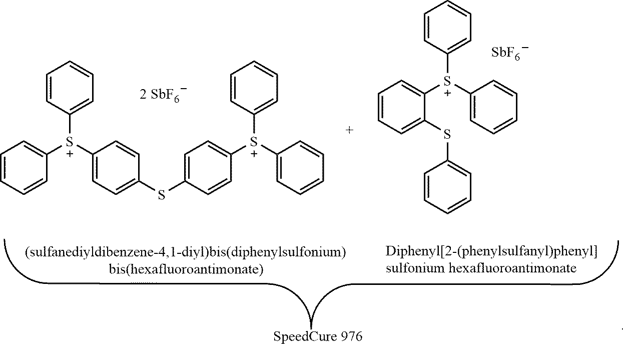

Sulfonium salts such as triphenylsulfonium triflate may also be used.

Peroxides such as dibenzoyl peroxide, lauroyl peroxide, dicumyl peroxide, di-tert-butyl peroxide, cumyl hydroperoxide, tert-butyl perbenzoate, cyclohexanone peroxide, methyl ethyl ketone hydroperoxide, acetylacetone peroxide, tert-butyl peroctoate, bis-2-ethylhexyl peroxide dicarbonate or tert-butyl peracetate, or 2-butanone peroxide, may also be used as oxidation agent in the context of the present invention. Preferably, the oxidation agent may not be a silicone-type peroxide, such as triphenyl(t-butylperoxy) silane, triphenyl(α,α′-dimethylbenzylperoxy) silane, and diphenyl(α,α′-dimethylbenzylperoxy) silane.

Advantageously, the oxidation agent, for example iodonium salt, may be used in 0.1-10.0 wt%, preferably 0.1-8.0 wt%, preferably 0.1-5.0 wt%, most preferably 1.0-5.0 wt% based on the total weight of the polyfunctional cyclic ether component(s) + anhydride component(s).

### Imidazole-Type Accelerator

Advantageously, the imidazole-type accelerator may be selected from substituted or unsubstituted compounds comprising a fused or unfused imidazole ring. Advantageously, the imidazole-type accelerator may have the structure:

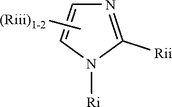

wherein
Ri represents H, C1-6alkyl, C6-10arylC1-6alkyl, or C6-10heteroarylC1-6alkyl ;
Rii represents H, C1-20alkyl, C6-10aryl ; and
each occurrence of Riii independently represents H, or C1-6alkyl ;wherein each of the foregoing alkyl, aryl and heteroayl moieties may bear one or more substituents selected from halogen, CN or OH.

For example, imidazole-type accelerators useable in the context of the invention may have the structure:

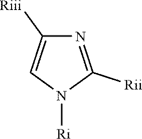

wherein Ri represents H, C1-6alkyl, C6-10arylC1-6alkyl, or C6-10heteroarylC1-6alkyl; preferably H, methyl, benzyl or 1,3,5-triazine-2,4-diamine-ethyl ;
Rii represents H, C1-20alkyl, or C6-10aryl ; preferably H, C1-6alkyl, C15-20alkyl, or phenyl; more preferably H, methyl, ethyl, C17alkyl, or phenyl; and
each occurrence of Riii independently represents H, or optionally substituted C1-6alkyl ; preferably H, methyl or —CH₂OH.

For example, imidazole-type accelerators may be selected from any one or more from Table 2:

TABLE 2

| | | |
|---|---|---|
| 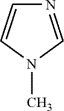 | 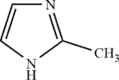 | 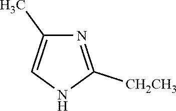 |
| 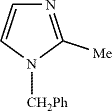 | 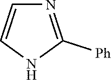 [SMILES: c1ccc(-c2ncc[nH]2)cc1] | 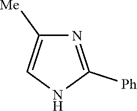 [SMILES: Cc1c[nH]c(-c2ccccc2)n1] |
| 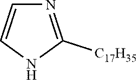 | 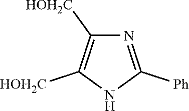 [SMILES: OCc1nc(-c2ccccc2)[nH]c1CO] | 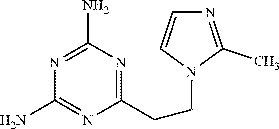 [SMILES: Cc1nccn1CCc1nc(N)nc(N)n1] |

Advantageously, the imidazole-type accelerator may be 1-methyl -1H-imidazole:

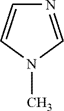

The presence of imidazole-type compounds as described above promotes a remarkable improvement in the reactivity of the polyaddition. Advantageously, imidazole-type compounds may be used alone or in admixtures of two or more imidazole-type compounds. Typically, imidazole-type compounds may be used in the range of 0.1-5.0 wt%, preferably 0.1-4.0 wt%, preferably 0.1-3.0 wt%, most preferably ≤2.5 wt% based on the total weight of the polyfunctional cyclic ether component(s) + anhydride component(s).

### Combination UV-Visible Photosensitizer/Iodonium/imidazole Accelerator Compound

The use of an imidazole-type accelerator compound may be advantageous in combination with a photoinitiating system comprising at least an iodonium salt as oxidation agent able to react with the photoinitiator or the photosensitizer, and at least one photoinitiator or photosensitizer that absorbs light under UV-visible irradiation. This type of combination may be particularly advantageously in that efficient photopolyaddition epoxy-anhydride may be obtained without the need for benzyl-type alcohol. For example, the photoinitiator or photosensitizer may be advantageously selected from type II photoinitiators such as benzophenone, xanthones, thioxanthones such as ITX, 2-ITX and CPTX, quinones, anthraquinones, and camphorquinone;

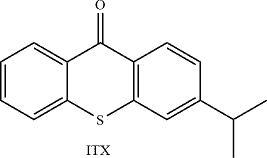

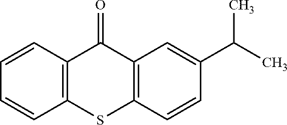 [SMILES: CC(C)c1ccc2sc3ccccc3c(=O)c2c1]

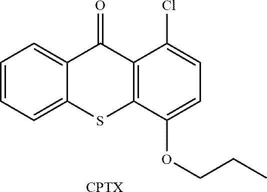

. Preferably a polyaromatic hydrocarbon photosensitizer such as pyrenes and anthracenes may be used instead of the type II photoinitiator. Mention may be made of DBA, for example:

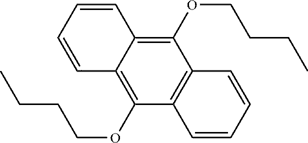 [SMILES: CCCCOc1c2ccccc2c(OCCCC)c2ccccc12]

. In both cases (type II photosensitizer and polyaromatic hydrocarbon photosensitizer) the following iodonium salts are particularly preferred:

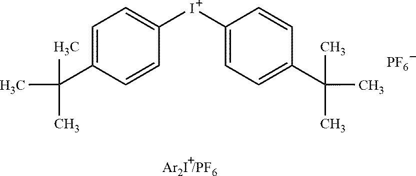

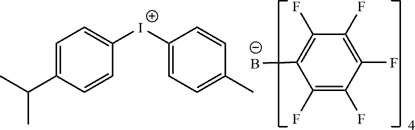

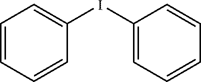

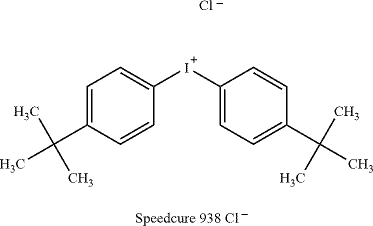

or

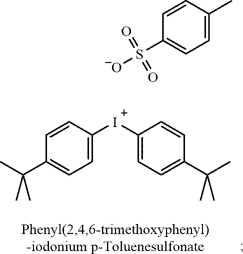

### Combination Near-Infrared Photosensitizer/Imidazole Accelerator Compound

The use of an imidazole-type accelerator compound may be advantageous in combination with a photoinitiating system comprising a photoinitiator or photosensitizer absorbing light under near-infrared irradiation. This type of combination may be particularly advantageous in that efficient epoxy-anhydride photopolyaddition may be obtained under mild irradiation conditions, without the use of an oxidation agent selected from iodonium salts, sulfonium salts, peroxides and thianthrenium salts, for example advantageously iodonium salts. For example, the photoinitiator or photosensitizer may be advantageously selected from photoinitiators or photosensitizers in the red to near infrared include dyes that generate heat when exposed to a 625-2500 nm light source, for example when exposed to a 625-1500 nm light irradiation. Advantageously, the photoinitiator or photosensitizer may be selected from cyanine dyes, such as those described previously. For example, any one or more of the following may be used:

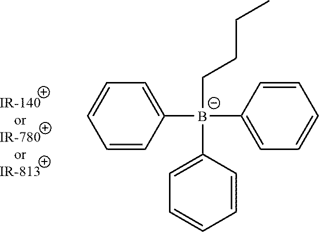

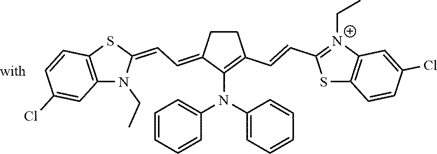

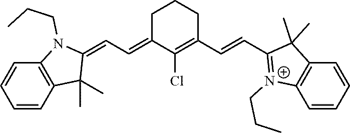 [SMILES: CCCN1/C(=C/C=C2\CCCC(/C=C/C3=[N+](CCC)c4ccccc4C3(C)C)=C2Cl)C(C)(C)c2ccccc21]

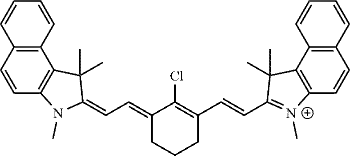 [SMILES: CN1/C(=C/C=C2\CCCC(/C=C/C3=[N+](C)c4ccc5ccccc5c4C3(C)C)=C2Cl)C(C)(C)c2c1ccc1ccccc21]

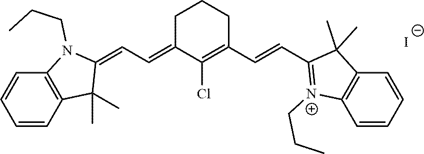 [SMILES: CCCN1/C(=C/C=C2\CCCC(/C=C/C3=[N+](CCC)c4ccccc4C3(C)C)=C2Cl)C(C)(C)c2ccccc21 ; [I-]]

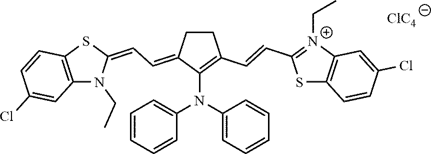

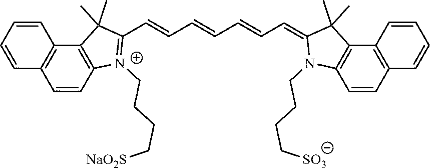

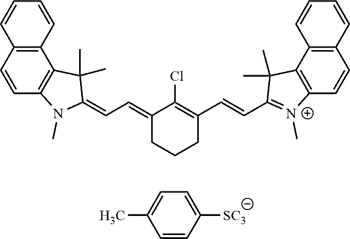

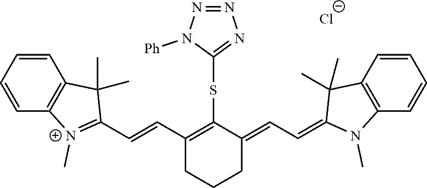 [SMILES: CN1/C(=C/C=C2\CCCC(/C=C/C3=[N+](C)c4ccccc4C3(C)C)=C2Sc2nnnn2-c2ccccc2)C(C)(C)c2ccccc21 ; [Cl-]]

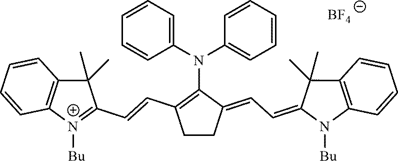

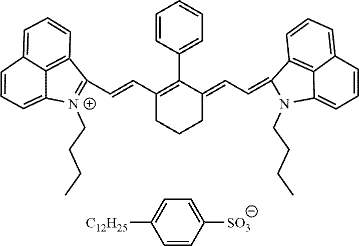

Preferably IR-813-toluene sulfonate may be used.

As for the imidazole accelerator compound, it may be selected from imidazole compounds as defined previously, preferably any one or more from Table 2, for example 1-methyl -1H-imidazole.

### Benzyl-Type Alcohol

Advantageously, the benzyl-type alcohol may be selected from any suitable alcohol featuring an —OH group on a carbon atom α or β to an aromatic or heteroaromatic nucleus known in the art.

Benzyl-type alcohols useable in the context of the present invention may be represented by:

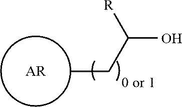

or

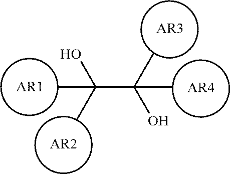

wherein:
AR, AR1, AR2, AR3 and AR4 independently represent an optionally substituted C6-C10 aryl or heteroaryl moiety (substituents may include halogen, linear or branched C1-6alkyl or linear or branched C1-6heteroalkyl);
R represents H, linear or branched C1-6alkyl; preferably R represents H or methyl.

For example AR may represent an optionally substituted phenyl or N-carbazolyl group:

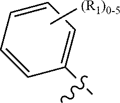

or

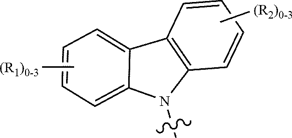

wherein each occurrence of R1, R2 and R3 independently represents H, halogen, linear or branched C1-6alkyl or linear or branched C1-6heteroalkyl.

For example, AR1, AR2, AR3 and AR4 may independently represent an optionally substituted phenyl group.

For example, benzyl alcohol may be used. The following benzyl-type alcohols may also be used:

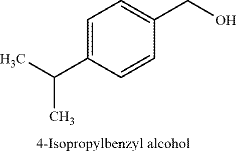

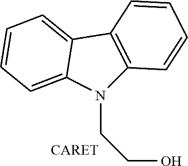

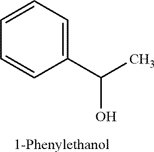

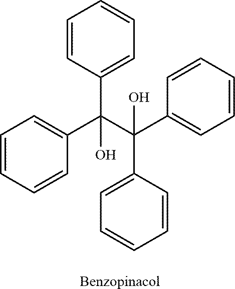

The presence of benzyl-type alcohol promotes a remarkable improvement in the reactivity of the polyaddition. Advantageously, benzyl-type alcohol additives may be used alone or in admixtures of two or more benzyl-type alcohols. Advantageously, benzyl-type alcohol additives may be used together with a photoinitiating system comprising at least one oxidation agent able to react with the photoinitiator or the photosensitizer, selected from iodonium salts, sulfonium salts, peroxides and thianthrenium salts, most advantageously iodonium salts. Alternatively, benzyl-type alcohol additives may also be used together with a photoinitiating system comprising an imidazole-type accelerator compound, as described previously, without an oxidation agent mentioned above (onium salts, sulfonium salts, peroxides or thianthrenium salts). However, when benzyl-type alcohol additives are used, it is preferably done with a photoinitiating system comprising at least one oxidation agent able to react with the photoinitiator or the photosensitizer, selected from iodonium salts, sulfonium salts, peroxides and thianthrenium salts, most advantageously iodonium salts. Typically, benzyl-type alcohol additives may be used in the range of 0.1-5.0 wt%, preferably 0.1-4.0 wt%, preferably 0.1-3.0 wt%, most preferably ≤2.5 wt% based on the total weight of the polyfunctional cyclic ether component(s) + anhydride component(s). For example about 2 wt% of benzyl-type alcohol may be used based on the total weight of the polyfunctional cyclic ether component(s) + anhydride component(s). Some preferred combinations include, but are not limited to: 4-isopropylbenzyl alcohol/2-ITX, CARET/2-ITX, 1-phenylethanol/2-ITX, 1-phenylethanol/CPTX, 4-isopropylbenzyl alcohol/DBA, 1-phenylethanol/DBA, CARET/DBA, benzopinacol/DBA.

### Combination UV-Visible Photosensitizer/Iodonium/benzyl-Type Alcohol

The use of a benzyl-type alcohol of structure:

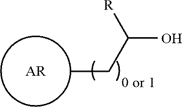

or

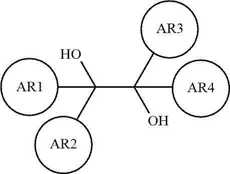

wherein R and AR1-Ar4 are as defined above, may be advantageous in combination with a photoinitiating system comprising at least an iodonium salt as oxidation agent able to react with the photoinitiator or the photosensitizer, and at least one photoinitiator or photosensitizer that absorbs light under UV-visible irradiation. This type of combination may be particularly advantageously in that efficient photopolyaddition epoxy-anhydride may be obtained without the need for an imidazole-type accelerator. For example, the photoinitiator or photosensitizer may be advantageously selected from type II photoinitiators such as benzophenone, xanthones, thioxanthones such as ITX, 2-ITX and CPTX, quinones, anthraquinones, and camphorquinone;

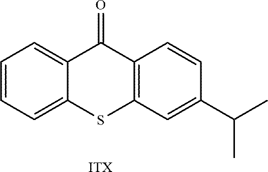

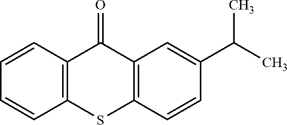 [SMILES: CC(C)c1ccc2sc3ccccc3c(=O)c2c1]

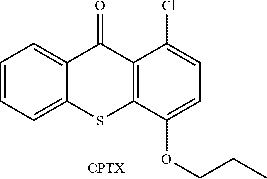

. Preferably thioxanthone compounds such as ITX, 2-ITX and CPTX may advantageously be used, more preferably ITX or 2-ITX. The benzyl-type alcohol may be advantageously selected from 4-isopropylbenzyl alcohol, CARET, 1-phenylethanol, or benzopinacol, preferably 4-isopropylbenzyl alcohol, CARET, or 1-phenylethanol, more preferably 1-phenylethanol.

A polyaromatic hydrocarbon photosensitizer such as pyrenes and anthracenes may be used instead of the type II photoinitiator. Mention may be made of DBA, for example:

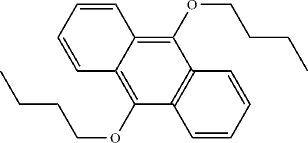 [SMILES: CCCCOc1c2ccccc2c(OCCCC)c2ccccc12]

. The benzyl-type alcohol used in combination with an anthracene-type photosensitizer such as DBA may be advantageously selected from 4-isopropylbenzyl alcohol, CARET, 1-phenylethanol, or benzopinacol, preferably CARET, or 1-phenylethanol.

In both cases (type II photosensitizer and polyaromatic hydrocarbon photosensitizer) the following iodonium salts are particularly preferred:

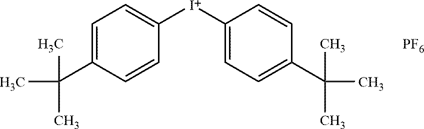 [SMILES: CC(C)(C)c1ccc([I+]c2ccc(C(C)(C)C)cc2)cc1 ; "PF6"]

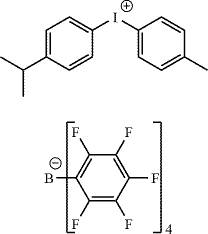

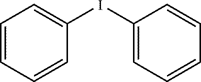

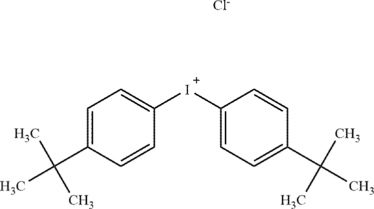 [SMILES: [Cl-] ; CC(C)(C)c1ccc([I+]c2ccc(C(C)(C)C)cc2)cc1]

or

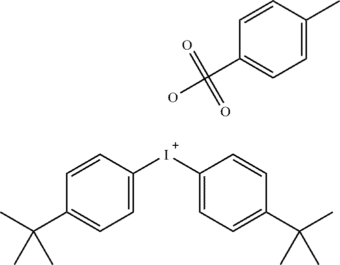

### Combination Near-Infrared Photosensitizer/Iodonium//Imidazole Accelerator Compound/Benzyl-Type Alcohol

The use of a benzyl-type alcohol of structure:

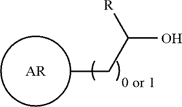

or

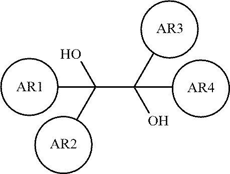

wherein R and AR1-Ar4 are as defined above, may be advantageous in combination with a photoinitiating system comprising at least an iodonium salt as oxidation agent able to react with the photoinitiator or the photosensitizer, at least one photoinitiator or photosensitizer that absorbs light under near-infrared irradiation, and at least one imidazole accelerator compound.

This type of combination may be particularly advantageously in that efficient photopolyaddition epoxy-anhydride may be obtained under mild irradiation conditions. For example, the photoinitiator or photosensitizer may be advantageously selected from photoinitiators or photosensitizers in the red to near infrared include dyes that generate heat when exposed to a 625-2500 nm light source, for example when exposed to a 625-1500 nm light irradiation. Advantageously, the photoinitiator or photosensitizer may be selected from cyanine dyes, such as those described previously. For example, any one or more of the following may be used:

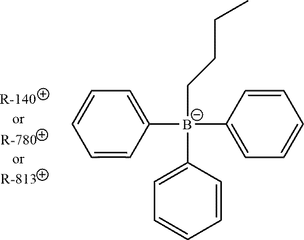

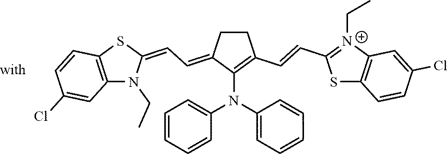

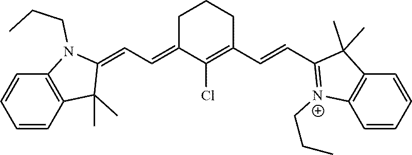 [SMILES: CCCN1/C(=C/C=C2\CCCC(/C=C/C3=[N+](CCC)c4ccccc4C3(C)C)=C2Cl)C(C)(C)c2ccccc21]

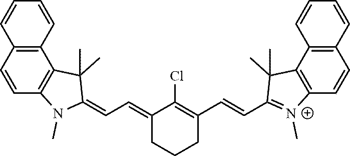 [SMILES: CN1/C(=C/C=C2\CCCC(/C=C/C3=[N+](C)c4ccc5ccccc5c4C3(C)C)=C2Cl)C(C)(C)c2c1ccc1ccccc21]

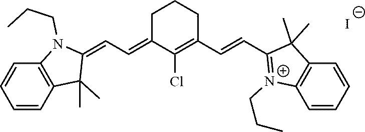 [SMILES: CCCN1/C(=C/C=C2\CCCC(/C=C/C3=[N+](CCC)c4ccccc4C3(C)C)=C2Cl)C(C)(C)c2ccccc21 ; [I-]]

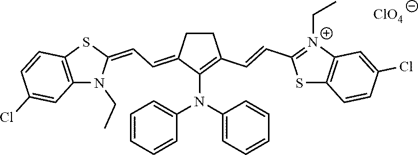

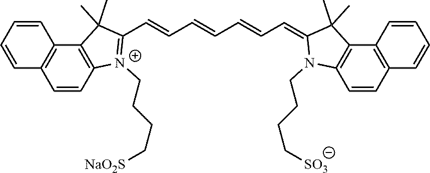

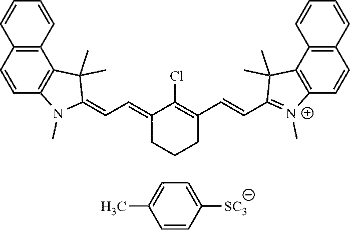

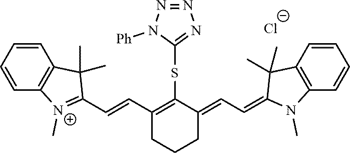 [SMILES: CN1/C(=C/C=C2\CCCC(/C=C/C3=[N+](C)c4ccccc4C3(C)C)=C2Sc2nnnn2-c2ccccc2)C(C)(C)c2ccccc21 ; [Cl-]]

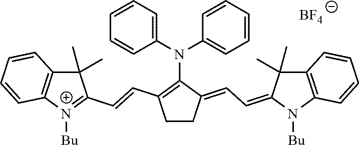

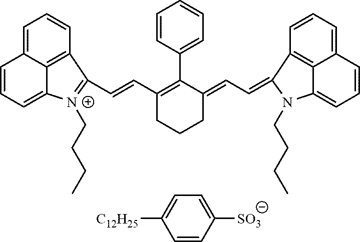

Preferably IR-813-toluene sulfonate may be used.

The benzyl-type alcohol may be advantageously selected from 4-isopropylbenzyl alcohol, CARET, 1-phenylethanol, or benzopinacol, preferably CARET. As for the imidazole accelerator compound, it may be selected from imidazole accelerator compounds as defined previously, preferably any one or more from Table 2, for example 1-methyl -1H-imidazole.

### Methods and Uses

In another aspect, the present invention provides the use of a photoinitiator or photosensitizer in combination with an oxidation agent selected from iodonium salts, sulfonium salts, peroxides and thianthrenium salts, for accelerated photopolyaddition of cyclic ether-anhydride resins under UV-visible to near-infrared irradiation. Preferably, the oxidation agent may be selected from iodonium salts, peroxides and thianthrenium salts; more preferably iodonium salts and thianthrenium salts.

In another aspect, the present invention provides the use of a photoinitiator or photosensitizer in combination with an oxidation agent selected from iodonium salts, sulfonium salts, peroxides and thianthrenium salts, for dark curing cyclic ether-anhydride resins under UV-visible to near-infrared irradiation. As used herein, the term “dark curing” refers to continued polymerization after the UV-visible to near-infrared light source has been removed, i.e., the polymerization is not immediately terminated when the UV-visible to near-infrared light source is removed (the polyaddition continues by thermal self-curing process).The present invention therefore provides a system for dark curing cyclic ether-anhydride resins in an acceptable time frame and to a sufficient depth using a UV-visible to near-infrared light source -initiated two-component system. Preferably, oxidation agent may be selected from iodonium salts, peroxides and thianthrenium salts; more preferably iodonium salts and thianthrenium salts, most preferably iodonium salts.

In yet another aspect, the present invention provides a process for accelerated curing of a cyclic ether- anhydride resin comprising the step of exposing to a UV-visible to near-infrared irradiation, preferably of intensity I > 25 mW/cm², a composition comprising:
at least one polyfunctional cyclic ether component comprising at least two cyclic ether moieties; and
at least one anhydride component comprising at least one carboxylic anhydride moiety;
in the presence of a photoinitiating system generating catalytic species comprising at least one suitable photoinitiator or photosensitizer that absorbs light at the desired UV-visible to near-infrared irradiation under which the composition is to be cured; and (i) at least one oxidation agent able to react with the photoinitiator or the photosensitizer, selected from iodonium salts, sulfonium salts, peroxides and thianthrenium salts; and/or (ii) at least one accelerator of epoxy-anhydride polyaddition processes selected from imidazoles.

Preferably, the oxidation agent may be selected from iodonium salts, peroxides or thianthrenium salts; more preferably iodonium salts or thianthrenium salts, most preferably iodonium salts.

The polyfunctional cyclic ether component, the anhydride component, the photoinitiator/photosensitizer, the oxidation agent and the imidazole accelerator may be as defined in any variant described above and herein. Advantageously, the process may be carried out at a moderate radiation intensity, for example 25 mW/cm² ≤ I ≤ 100 W/cm², preferably 25 mW/cm² ≤ I ≤ 20 W/cm². Advantageously, the duration of exposure of the resin to UV-visible to near-infrared irradiation will depend on the irradiation intensity: the higher the intensity, the smaller the duration time necessary. Typically, for practical purposes, the duration of exposure of the resin to UV-visible to near-infrared irradiation should be ≤10 minutes, more ≤5 minutes. Advantageously, the duration of exposure of the resin to UV-visible to near-infrared irradiation preferably may be 1 to 800 seconds, preferably between 1 and 300 seconds, more preferably between 1 and 150 seconds.

In all of the above aspects, a benzyl-type alcohol comprising an —OH group on a carbon atom α or β to an aromatic or heteroaromatic nucleus may be used as additive for enhancing the curing process of a cyclic ether- anhydride resin according to the present invention. The benzyl-type alcohol may be as defined in any variant described above and herein.

Advantageously, the process may further comprise a step of mixing or impregnating composite reinforcements with said composition prior to UV, Visible, to near-infrared irradiation. The composite reinforcements may be any suitable reinforcements known in the art, and will be selected depending of the intended composite, and desired composite properties. For example, the composite reinforcements may be glass fibers, carbon fibers, aramid fibers, basalt fibers, silica fibers, polymer fibers, natural fibers or a mixture of two or more of those.

One stark advantage of the process is that crosslinking/curing of the composition may occur throughout the whole thickness of the composition, even in the presence of reinforcements. This allows the manufacture of thick composites, particularly laminate composites. For example, the sample to be cured/crosslinked is at least 1 cm thick, preferably at least 2 cm thick, mist preferably > 3 cm thick.

An advantage of the photopolyaddition process according to the invention is that it is not oxygen sensitive, or it is resistant to oxygen inhibition. Accordingly, the process may be carried out under air.

In yet another aspect, the present invention provides the use of an alcohol comprising an —OH group on a carbon atom α or β to an aromatic or heteroaromatic nucleus for enhancing a curing process of a cyclic ether-anhydride resin according to the present invention, as described in any variant herein.

It is to be understood that all the variants described above, notably for the various components for the curable compositions according to the invention are applicable mutatis mutandis to this section, and will be understood to apply to the processes/polymerization methods/uses defined in this section. This includes all the variants described in the “DETAILED DESCRIPTION OF CERTAIN PREFERRED EMBODIMENTS OF THE INVENTION” section of this document, including any one and all variants relating to the a) polyfunctional cyclic ether component, b) anhydride component, c) photosensitizer or photoinitiator, d) the oxidation agent, e) the imidazole-type accelerator compound, and f) the benzyl-type alcohol. In addition, all the variants relating to the irradiation light source described in the present document are applicable mutatis mutandis to this section. All the variants relating to the imidazole-type accelerator and benzyl-type alcohol additive described in the present document are applicable mutatis mutandis to this section. In addition, all the variants described below relating to the irradiation light source described below in the present document are applicable mutatis mutandis to this section.

### Articles and Composites

In another aspect, the present invention provides a resin casting, film or coated substrate comprising a cyclic ether- anhydride resin obtained by an accelerated curing process according to the invention, as described generally and in any variants herein. Advantageously, the substrate may include metal, glass, ceramic, plastic, adhesive polymer, composite, concrete or wood.

Also provided is a process for forming the substrate defined above, said process comprising spraying, coating or applying said composition onto a substrate and subsequently curing said composition under UV-visible to near-infrared irradiation. Advantageously, the UV-visible to near-infrared irradiation may be of moderate intensity (e.g., as low as 25 mW/cm² or even lower, for example 25 mW/cm² ≤ I ≤ 20 W/cm²).

In another aspect, the present invention provides an adhesive layer or bonding agent comprising a cyclic ether- anhydride resin obtained by an accelerated curing process according to the invention, as described generally and in any variants herein.

In another aspect, the present invention provides a composite comprising (i) a cyclic ether- anhydride resin obtained by an accelerated curing process according to the invention, as described generally and in any variants herein, and (ii) a reinforcing agent. Advantageously, the reinforcing agent may include fibers, such as glass fibers, carbon fibers, aramid fibers, basalt fibers, silica fibers, polymer fibers, natural fibers or a mixture of two or more of those.

In another aspect, the present invention provides the use of a composition according to the invention, as described generally and in any variants herein, for increasing the delamination strength of laminated composite materials.

Likewise, for each of the above three aspects, the variants described above, notably for the various components for the compositions according to the invention are applicable mutatis mutandis to this section, and will be understood to apply to the articles/composites materials defined in this section. This includes all the variants described in the “DETAILED DESCRIPTION OF CERTAIN PREFERRED EMBODIMENTS OF THE INVENTION” section of this document, including any one and all variants relating to the a) polyfunctional cyclic ether component, b) anhydride component, c) photosensitizer or photoinitiator, d) the oxidation agent, e) the imidazole-type accelerator compound, and f) the benzyl-type alcohol. All the variants relating to the imidazole-type accelerator and benzyl-type alcohol additive described in the present document are applicable mutatis mutandis to this section. In addition, all the variants described below relating to the irradiation light source described below in the present document are applicable mutatis mutandis to this section.

Advantageously, the methods/processes according to the invention can generally be carried out using conventional methods of preparing the above described cyclic ether/ anhydride adducts according to the present invention in a suitable mixing device such as, but not limited to, stirred tanks, dissolvers, homogenizers, microfluidizers, extruders, or other equipment conventionally used in the field.

When the method/process of the invention is used in the preparation of composites and / or laminated articles, the process may further comprise a step of adding a material / reinforcement designed for this purpose using known methods.

Advantageously, the method/process may further comprise a step of impregnating composite reinforcements with a mixture of the composition according to the present invention and a mixture of at least one polyfunctional cyclic ether component and at least one anhydride component according to the invention, in a mold, such as a silicone mold, prior to the application of light source.

Advantageously, the composite reinforcements may be any reinforcing conventionally used in the manufacture and implementation of composite materials. For example, the composite reinforcements may be selected from:
Glass fibers
Carbon fibers
Aramid fibers (Kevlar®)
Basalt fibers
Silica fibers
Silicon carbide fibers
Polymer fibers
Vegetal fibers (hemp, flax ...)
Mineral, metallic or organic fillers (for example gravel, sand, glass beads, carbonate powder, alumina hydrate powder, steel powder, aluminum powder, polymer particles, titanium oxide, alumina, etc ...)

Advantageously, the composite reinforcements may be selected from glass fibers, carbon fibers, aramid fibers, basalt fibers, silica fibers, polymer fibers (such as polyesters, poly (p-phenylene-2,6 -benzobisoxazole), aliphatic and aromatic polyamides, polyethylene, polymethyl methacrylate, polytetrafluoroethylene), natural fibers (such as nettle, flax or hemp fibers) ...

Advantageously, the composite reinforcements may be previously disposed in a mold, and then impregnated by a mixture of the UV-visible to red-NIR photoinitiating composition according to the invention and a mixture of at least one polyfunctional cyclic ether component and at least one anhydride component (step(i)), before application of light radiation (step (ii)).

Alternatively, composite reinforcements may be pre-impregnated with a mixture of the photo-initiating composition and a mixture of at least one polyfunctional cyclic ether component and at least one anhydride component according to the invention. Then the resulting mixture may be deposited / spread evenly over the mold, either manually or using an automated robot, in the case of mass production.

The process may further include a step of adding any other additive conventionally used in the field of resins, composite materials and applications. Examples of suitable additives include:
pigments, such as colored pigments, fluorescent pigments, electrically conductive pigments, magnetically shielding pigments, metal powders, scratch-proofing pigments, organic dyes or mixtures thereof;
light stabilizers such as benzotriazoles or oxalanilides;
crosslinking catalysts such as dibutyltin dilaurate or lithium decanoate;
slip additives;
defoamers;
emulsifiers, especially nonionic emulsifiers such as alkoxylated alkanols and polyols, phenols and alkylphenols or anionic emulsifiers, such as alkali metal salts or ammonium salts of alkanecarboxylic acids, alkanesulfonic acids, alkanol sulfonic acids or alkoxylated polyols, phenols or alkyl phenols;
wetting agents such as siloxanes, fluorinated compounds, carboxylic monoesters, phosphoric esters, polyacrylic acids or their copolymers, polyurethanes or acrylate copolymers, which are commercially available under the trademark MODAFLOW ® or DISPERLON ®;
adhesion promoters such as tricyclodecan-dimethanol;
leveling agents;
film-forming adjuvants such as cellulose derivatives;
flame retardants;
sag control agents such as ureas, modified ureas and / or silicas,
rheology control additives such as those described in patent documents WO 94/22968 , EP0276501A1 [8], EP0249201A1 [9], and WO 97/12945 [10];
crosslinked polymeric microparticles, as described for example in EP0008127A1 ;
inorganic phyllosilicates such as aluminum magnesium silicate, magnesium sodium silicates or magnesium fluoride sodium lithium phyllosilicates of montmorillonite type;
silicas such as aerosils® silicas;
flatting agents such as magnesium stearate; and/or
tackifiers.

Mixtures of at least two of these additives are also suitable in the context of the invention.

As used herein, the term “tackifier” refers to polymers which increase the tack properties, that is to say, the intrinsic viscosity or self-adhesion, the compositions so that, after a slight pressure a short period, they adhere firmly to surfaces.

### Irradiation Light Source

For purposes of the present invention, any light source known in the art, capable of generating light in the 200-2500 nm region, for example in the range of 200-1600 nm, may be used. For example, light emitted from LED bulbs, laser, laser diode, low pressure mercury and argon lamps, fluorescent light systems, electric arc-light sources, high intensity light sources may be used.

For example, the light source may generate light in the visible and middle-to-near UV spectrum, ranging from 200-900 nm in wavelengths. Any source of visible light or middle-to-near UV light may be used. By visible light is meant the visible spectrum in the wavelengths from about 390 to 700 nm. By middle-to-near UV light is meant the light spectrum in the wavelengths from about 200 to 390 nm. Sources of visible light include LED bulbs, laser diode, green fluorescence bulbs, halogen lamps, household lamps including energy-saving lamps, or natural light. Sources of middle-to-near UV light include BLB type lamps, Mercury-vapor lamps, Sodium vapor lamps or Xenon arc lamps.

Advantageously, the light source may generate light in the red region of the light spectrum (i.e., 625-750 nm). For example, light sources that may be used to that effect include LED bulb, laser, laser diode, fluorescent light system, electric arc light source, high intensity (metal halide 3000 K, high pressure sodium lamp), Xenon light, Mercury-Xenon light.

Advantageously, the light source may generate light in the near-infrared region of the light spectrum (i.e., 700-2500 nm, for example 700-1500 nm). For example, light sources that may be used to that effect include NIR LEDs, NIR lasers, low pressure mercury and argon lamps (696-1704 nm) Tungsten light source, tungsten halogen light source, Nd:Yag laser, Nd:YVO₄, Nd:CidVO₄, Nd:LuVO₄, CO₂ laser, the intensity of which (especially for the most powerful irradiation light source systems such as lasers (e.g., Nd:Yag lasers)) may be tuned down to the desired intensity (for example 25 mW/cm² ≤ I ≤100 W/cm², preferably 25 mW/cm² ≤ I ≤ 20 W/cm²) for purposes of reducing the present invention to practice.

An important advantage of the invention is that cyclic ether-anhydride polyaddition can be effected under moderate irradiation intensity, typically as low as 25 mW/cm² or even lower.

It is understood that the light source may be a tunable power light source; that is one that is equipped with tunable power, so as be able to adjust the power of the light irradiation (in UV-visible to near infrared range), if needed. Such tunable power light source may also be used to determine the light intensity threshold at which a particular dye starts to absorb at any given wavelength, and therefore to fine-tune the wavelength/irradiation intensity that may be used to obtain optimal conditions for polymerization.

Likewise, the absorbance profiles of dyes known to absorb in the UV-visible to near infrared range of the light spectrum are known or can be readily determined by running an absorbance vs. wavelength graph. As will be readily apparent throughout the teachings of the present document, if a particular dye exhibits low/moderate absorbance at a given wavelength, one may still proceed with that particular dye at the same given wavelength by increasing the intensity of the light irradiation. This may be done by using a tunable power light source for example, such as commercially available tunable power red to near-infrared light sources.

When a heat-generating dye in the red-NIR is used, the light source may be preferably selected as a function of the heat-generating dye to be used: most advantageously, the light source may be one that emits light in the wavelength range where the dye most readily absorbs the light to generate an exotherm, which thermally initiates the polymerization process. The heat-generating profiles of dyes known to absorb in the red or near infrared range of the light spectrum are known or can be readily determined by running an exotherm vs. wavelength graph using thermal imaging.

Briefly, the heat-generating potential of a red-NIR dye may be determined using an infrared thermal imaging camera, such as (Fluke TiX500) with a thermal resolution of about 1° C. and a spatial resolution of 1.31 mRad by recording the heat released by the red-NIR dye in the resin (mixture of at least one polyfunctional cyclic ether component and at least one anhydride component according to the invention) under exposition to the suitable irradiation is described in detail in [12].

As discussed above, if a particular dye generates low/moderate heat at a given wavelength, one may still proceed with that particular dye at the same given wavelength by increasing the intensity of the light irradiation. This may be done by using a tunable power light source for example, such as commercially available tunable power red to near-infrared light sources.

### Synthetic Methods

The practitioner has a well-established literature of synthetic organic and inorganic chemistry and polymer chemistry to draw upon, in combination with the information contained herein, for guidance on synthetic strategies, protecting groups, and other materials and methods useful for the synthesis of the compositions and cyclic ether-anhydride polyaddition adducts according to the present invention. For example, the reader may refer to the Exemplification section below, and references cited therein for synthetic approaches suitable for the preparation of some of the compositions and cyclic ether-anhydride polyaddition materials described herein. The reader may refer for example to references [13] and [14], which relate to phthalocyanine dyes. These are often simple to synthesize with relatively high yields and have been used as commercial pigments and dyes for decades.

The present invention finds application in a wide variety of fields, including polymer synthesis, polymer and composite preparation, high adhesion adhesives, high performance composites and adhesives.

The initiation of polymerization by light (UV, visible, NIR) or photopolymerization is a polymer synthesis technique that is recent and whose both industrial and academic demands are constantly growing. The development of new photoinitiator and/or monomer systems is currently in great demand. It concerns many fields of applications such as coatings, inks, 3D printing... One of the main defects of photopolymerization in its current state is the limited diversity of chemical compositions of photopolymerizing resins (acrylates, pure epoxides, thiol-ene,...). The majority is photopolymerized by a free radical polymerization (for example acrylates) which induces a very strong shrinkage effect and, as a result, limits the interest of these resins. Also the adhesion properties of current photopolymerizable resins are not competitive with cyclic ether/ anhydride resins, in particular epoxy/ anhydride resins, on most surfaces/substrates.

On the other hand, two-component cyclic ether/anhydride resins have a very important industrial success especially in the field of adhesives because they have very important adhesion properties on a variety of very important surfaces/substrates (glass, metal, concrete, plastic, composite, wood, etc...). However, the setting/curing times of these resins are very long (3-48 hours) at room temperature, which greatly limits the productivity of these processes. In many areas, therefore, faster curing resins are preferred (although with lower properties than cyclic ether/ anhydrides, such as epoxy/ anhydrides) as setting must occur within the first 10-20 minutes.

A stark advantage of the invention over existing compositions/processes is that it greatly surpasses the performances of existing materials/methods (conventional photopolymerization and polyaddition), while obviating their drawbacks: the resulting material (polyaddition cyclic ether-anhydride adduct) exhibits a low shrinkage while having a temporal (acceleration) and spatial control of polymerization, no volatile organic compounds emitted, the polymerization conditions are gentle (no need to heat the medium, non-hazardous irradiation wavelengths, low intensities used...), rapid polymerization, thick composite polymerization readily accessible.

The present invention provides for an unprecedented acceleration of cyclic ether-anhydride polyaddition reactions (lowering the reaction time from 3 hours via conventional processes, down to a few minutes (5-15 minutes) via the process of the present invention.

In summary, the present invention offers many advantages, including:
-> compared to conventional cyclic ether/ anhydride polyaddition, such as epoxy/ anhydride polyaddition:
   Allows unprecedented acceleration of curing time
   No need to heat the polymerization media (reaction at room temperature (20-25° C.))
   Better final mechanical properties of the polycyclic etheranhydride adduct because better conversion rates are obtained
-> compared to conventional photopolymerization:
   Allows access to photopolymerisable adhesives with much better adhesion properties on almost all substrates (e.g. glass, metal, concrete, plastic, composite, wood, etc.).
   Allows polymerization of composites (opaque samples)
   Allows the polymerization of thicker samples (of the order of a few centimetres, as compared to a few millimetres for visible light conventional photopolymerization and a hundred micrometres for UV light conventional photopolymerization)
   Allows to use longer photopolymerization wavelengths (therefore less energetic and safer for the user)
   Less expensive starting materials used
   2-component photoactivatable systems
   resistant to water inhibition
   resistant to oxygen inhibition

Other advantages may also emerge to those skilled in the art upon reading the examples below, with reference to the attached figures, which are provided as nonlimiting illustrations.

### EQUIVALENTS

The representative examples that follow are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. It should further be appreciated that the contents of those cited references are incorporated herein by reference to help illustrate the state of the art. The following examples contain important additional information, exemplification and guidance that can be adapted to the practice of this invention in its various embodiments and the equivalents thereof.

### EXEMPLIFICATION

The polymer materials and compositions of this invention and their preparation can be understood further by the examples that illustrate some of the processes by which these polymer materials and compositions are prepared or used. It will be appreciated, however, that these examples do not limit the invention. Variations of the invention, now known or further developed, are considered to fall within the scope of the present invention as described herein and as hereinafter claimed.

### Materials and Methods

### 1/Two-Component Mixing Procedure

All formulations were prepared from the bulk resin out at room temperature (RT) (21-25° C.). Unless otherwise indicated, about exactly 1.00±0.03 g epoxy (52%) mixed with 0.90±0.02 g anhydride (48%) during about 45 sec before each experiment. Throughout the Examples, % in epoxy component and anhydride component are expressed in wt % relative to the total weight epoxy component + anhydride component, without additives. The photoinitiators were first dissolved in the anhydride component. Their weights are given as a percentage of the total epoxy/anhydride mixture (e.g. 1 wt% CPTX corresponds to 20 mg CPTX in 2.00 g of epoxy/anhydride mixture without additives).

### 2/ RT-FTIR Spectroscopy

A Jasco 6600 Real-Time Fourier Transformed Infrared Spectrometer (RT-FTIR) was used to follow the reactive function conversion versus time for polyadditions of samples with a variety of thicknesses, for example 1.4 mm thick samples. The evolution of the near infrared epoxide peak was followed from 4470 to 4568 cm⁻¹. A LED@405 nm (Thorlabs) having a limited irradiance of 110 mW/cm² at the sample position was used for the photopolymerization experiments. Another laser diode LD@405 nm (CNI lasers, MDL-III-405-500 mW) having an intensity of 450 mW/cm² (at the sample position) was used for photopolyaddition under higher intensity. The emission spectra are already available in the literature. [15]

### 3/ Dynamic Mechanical Analysis (DMA) of the Materials

DMA measurements were carried out with shearing mode on a METTLER TOLEDO DMA 861 viscoanalyser. Cylindrical polymer samples for the DMA measurements had a diameter of 8 mm and thickness of 2 mm. This equipment meets the requirement of French ISO 9001 for regular calibration and reliable analyses.

### 4/ Monitoring Photopolymerization Reaction With Thermal Imaging Camera

An infrared thermal imaging camera (Fluke TiX500) was used to monitor the Photopolyaddition of the 4 mm samples. A LED@405 nm (Thorlabs, Solis 405C) having a conveniently adjustable irradiance of 0-1.1 W/cm² at the sample position was used for the Photopolyaddition experiments. Fluke SmartView4.1 software was used to present the images. A script - running under Spyder environment (Python language) - was used to recover temperature versus time (at the center of the sample) from raw Fluke data files. A complete description of thermal imaging features for photopolymerizations monitoring is reported in [12]

### 5/ Photorheology

A photorheometer from Thermofisher (haake - MARS TM) has been used to follow the mechanical properties (G′,G″) in real time upon irradiation.

### 6/ Chemical Compounds

All the reactants were selected with high purity and used as received. 1-chloro-4-propoxythioxanthone (CPTX) and Di-tertbutyl-diphenyl iodonium hexafluorophosphate (lod) were obtained from Lambson Ltd. Barium glass fillers (average diameter of 400 nm) were used for the preparation of composites. All fiberglass sheets carbon fiber sheets were obtained from Arkema.

All epoxy and anhydride monomers were obtained from Sigma Aldrich.

In the Examples that follows, all wt% in respect of the photoinitiators/photosensitizers, oxidation agent and optional benzyl-type alcohol additive and/or optional imidazole compound accelerator, are provided based on the total weight of epoxy/anhydride mixture used (e.g. 1 wt% CPTX corresponds to 20 mg CPTX in 2.00 g of epoxy/ anhydride mixture without additives).

### Example 1 - Photopolyaddition of Epoxy-Anhydride Resins in the UV-Visible

The epoxy-anhydride photopolyaddition according to the invention was carried out using the following components with a variety of UV-visible photoinitiators/photosensitizers (1 wt% 2-ITX, G1 or DBA):

Epoxide component

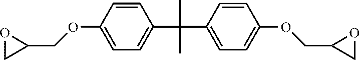 [SMILES: CC(C)(c1ccc(OCC2CO2)cc1)c1ccc(OCC2CO2)cc1]

| | |
|---|---|
| Anhydride component | lodonium salt |
| 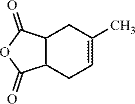 | 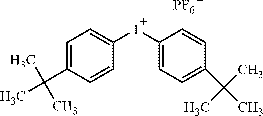 [SMILES: "PF6" ; CC(C)(C)c1ccc([I+]c2ccc(C(C)(C)C)cc2)cc1] |
| (4-methylcyclohex-4-ene-1,2-dicarboxylic anhydride) | |

All kinetics were performed under the following conditions:
Laser diode @ 405 nm, l = 450 mW / cm²
In thick sample 1.4 mm
Under air

The reagents were used in the following quantities: Epox A (52%) / MCH Anhydride (48%) / photoinitiator (1 wt %) /oxidation agent SC938 (2 wt%). All samples lead to over 80% epoxide conversion after 600 sec irradiation with laser diode @405 nm (l=450 mW/cm²), and tackfree polymers were obtained in all cases.

| Photoinitiator | % Epoxide conversion |
|---|---|
| 2-ITX | 84% |
| G1 | 95% |
| DBA | 87% |

### Example 2 - Photopolyaddition of Epoxy-Anhydride Resins in the Near-Infrared

Example 1 was repeated using 0.1% wt IR-813-p-toluenesulfonate as photoinitiator/photosensitizer, in the presence of 2 wt% imidazole accelerator compound

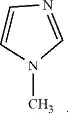

The kinetics were carried out under the following conditions:
Laser diode @ 785 nm, l = 2.5 W / cm²
In thick sample 1.4 mm
Under air

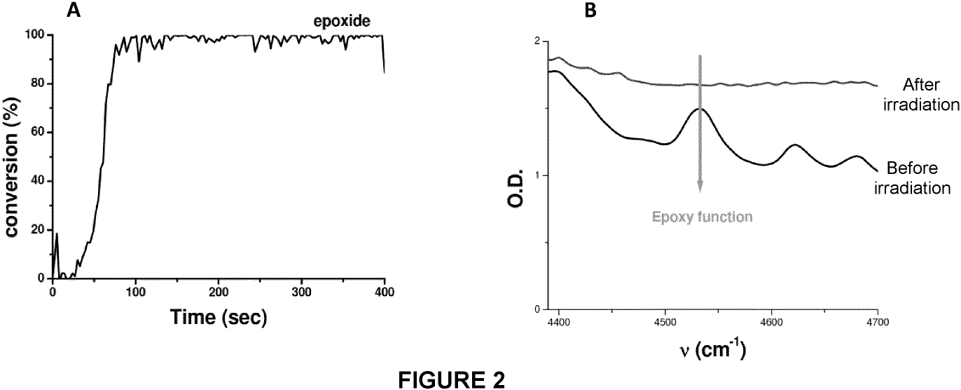

This lead to 100% epoxide conversion after less than 100 sec irradiation with laser diode @785 nm (I=2.5 W/cm²), and tackfree polymers were obtained in all cases. (FIG. 2)

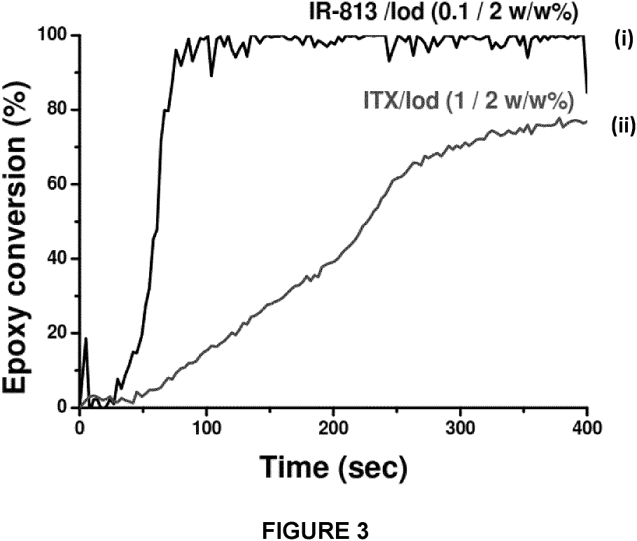

The comparative performance of 0.1 wt% IR-813/2 wt% lod/2 wt% imidazole accelerator compound @785 nm (I=2.5 W/cm²) was compared to the photoinitiator system 1 wt% ITX/2 wt% iod used in Example 1 @450 nm (I=450 mW/cm²). The comparative results are shown in FIG. 3, which reveals the excellent performance of the NIR dye IR-813 compared to UV-visible photosensitizer ITX.

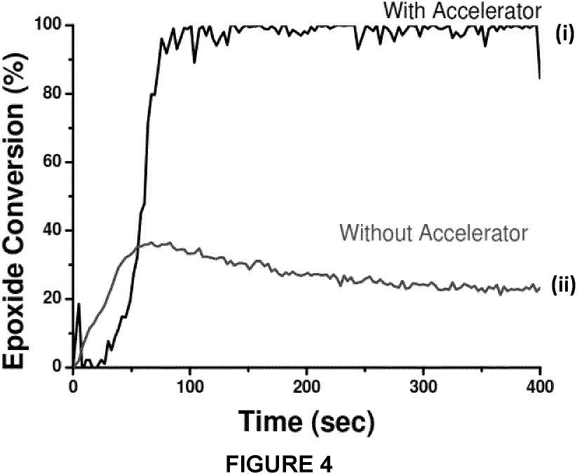

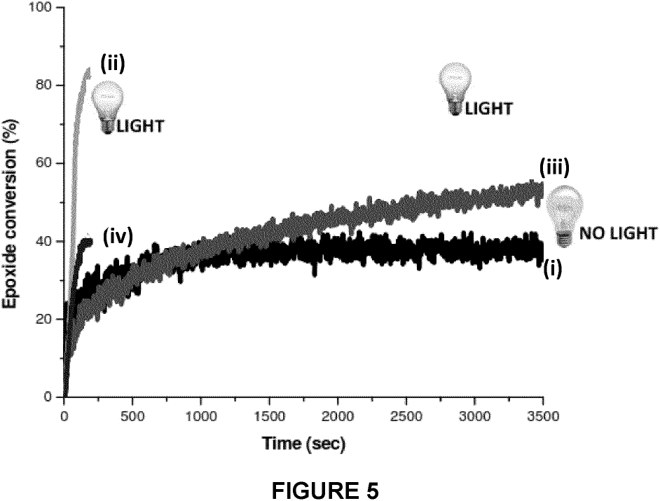

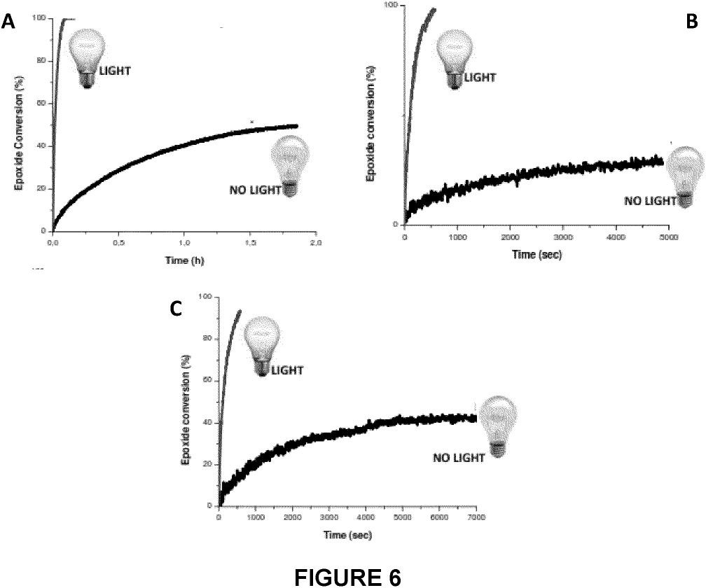

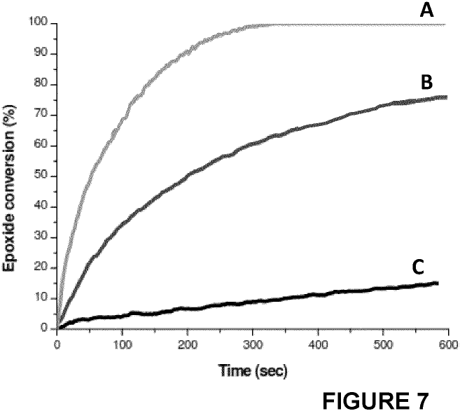

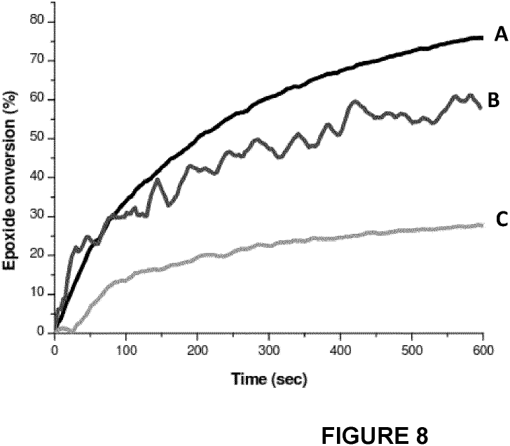

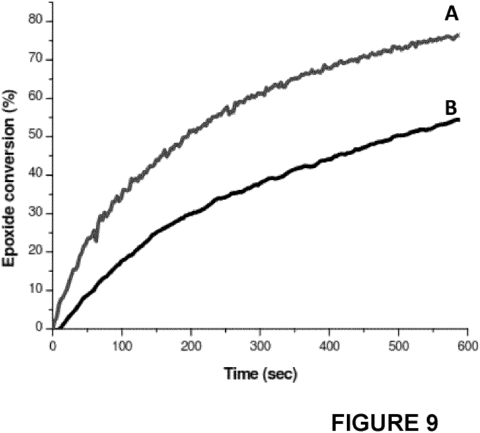

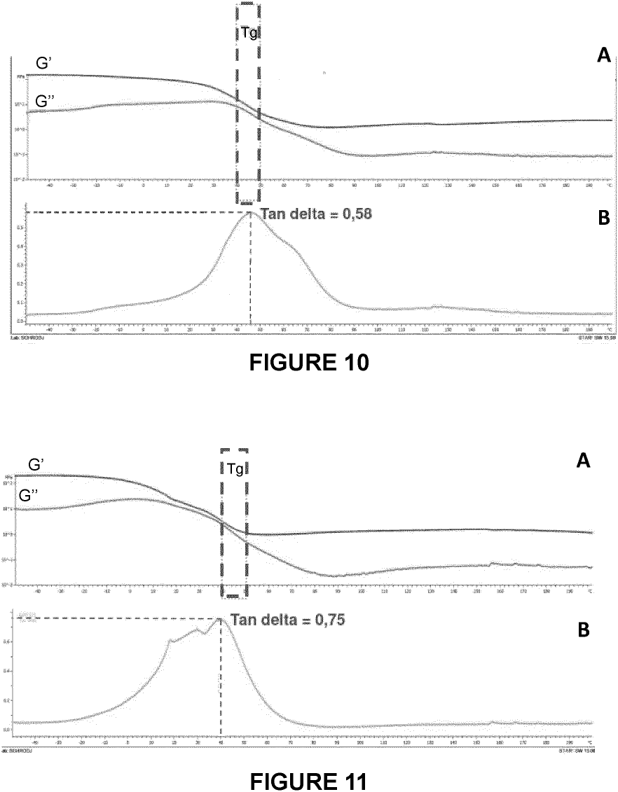

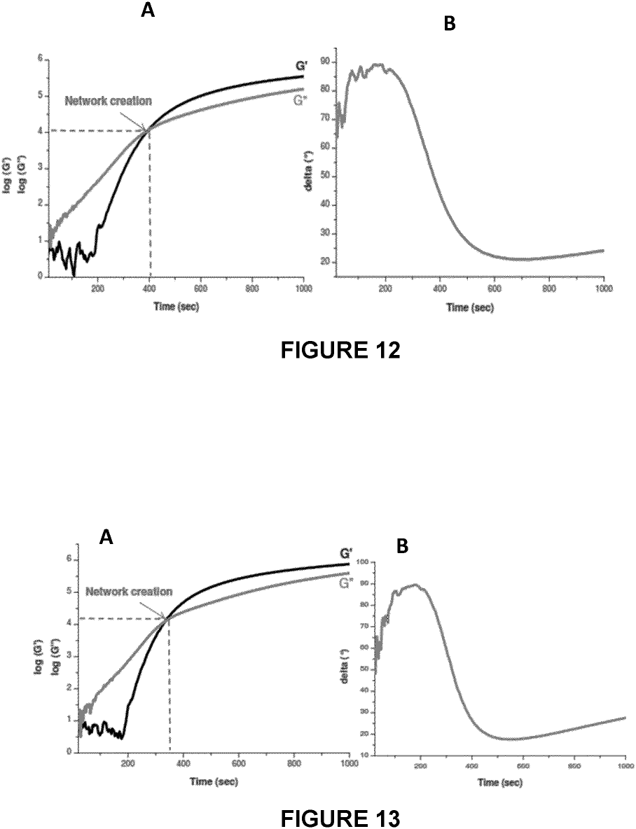

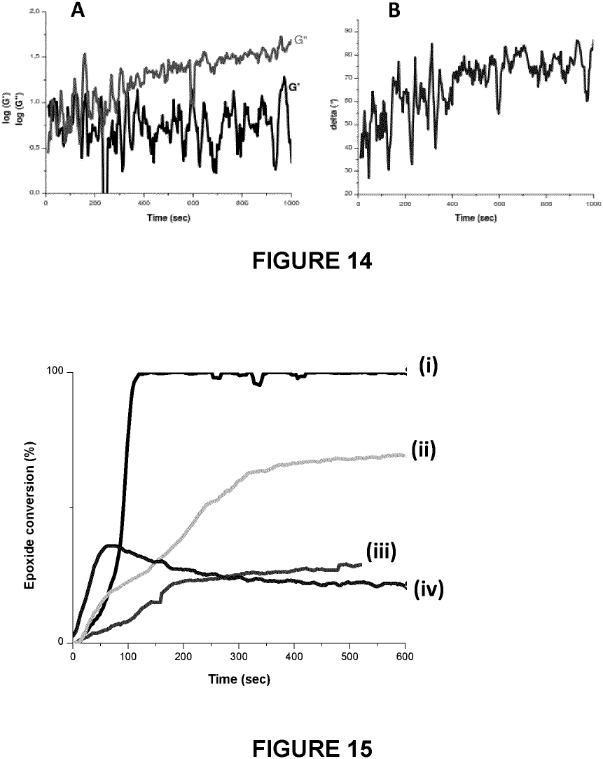

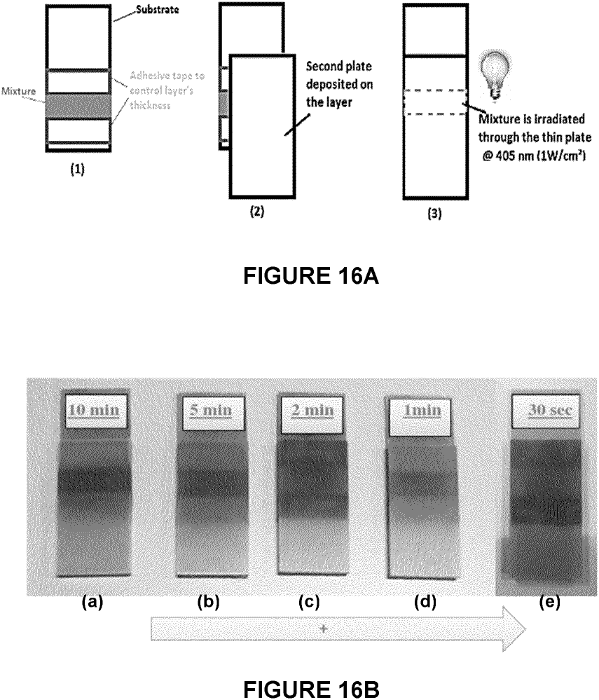

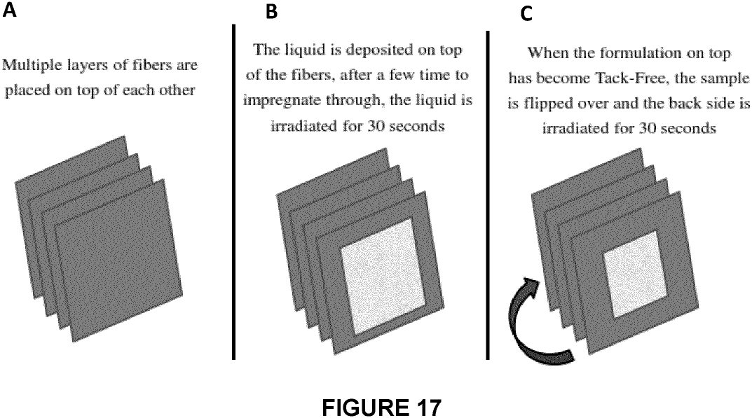

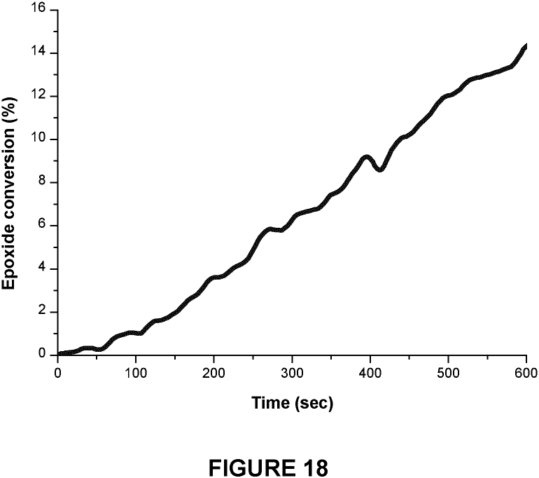

When IR-813 was used without imidazole accelerator compound, the epoxy-anhydride polyaddition proceeded, but less efficiently. This is shown in FIG. 4: the presence of the imidazole accelerator compound enhances the photopolyaddition reactivity.

### Example 3-Photopolyaddition of Epoxy-Anhydride Resins in the Near-Infrared In the Presence of Alcohol

The epoxy-anhydride photopolyaddition according to the invention was carried out using the following components:

Epoxide component

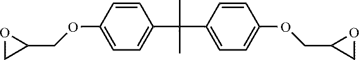 [SMILES: CC(C)(c1ccc(OCC2CO2)cc1)c1ccc(OCC2CO2)cc1]

| Anhydride component | lodonium salt |
|---|---|
| 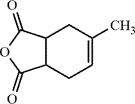 | 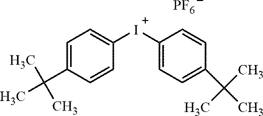 [SMILES: "PF6" ; CC(C)(C)c1ccc([I+]c2ccc(C(C)(C)C)cc2)cc1] |
| (4-methylcyclohex-4-ene-1,2-dicarboxylic anhydride) | |
| NIR photosensitizer | Imidazole-type accelerator |
| 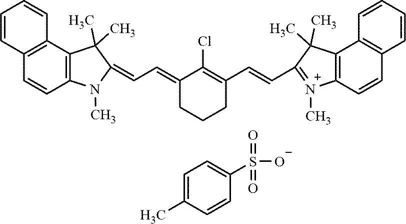 [SMILES: CN1/C(=C/C=C2\CCCC(/C=C/C3=[N+](C)c4ccc5ccccc5c4C3(C)C)=C2Cl)C(C)(C)c2c1ccc1ccccc21 ; Cc1ccc(S(=O)(=O)[O-])cc1] | 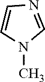 |

The kinetics were carried out under the following conditions:
Laser diode @ 785 nm, I = 2.5 W / cm²
In thick sample 1.4 mm
Under air

The reagents were used in the following quantities: Epox A (52%) / MCH Anhydride (48%) / photoinitiator IR-813 (0.1 wt %) /oxidation agent SC938 (2 wt %) / 2 wt% imidazole accelerator / 2 wt% CARET. All samples lead to 100% epoxide conversion after less than 100 sec irradiation with laser diode @785nm (I=2.5 W/cm2), and tackfree polymers were obtained in all cases.

### Example 4-photopolyaddition of Epoxy-anhydride Resins in the UV-Visible in The Presence of Alcohol

The epoxy-anhydride photopolyaddition according to the invention was carried out using the following components, with a variety of alcohols:

Epoxide component

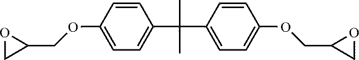 [SMILES: CC(C)(c1ccc(OCC2CO2)cc1)c1ccc(OCC2CO2)cc1]

| Anhydride component | lodonium salt |
|---|---|
| 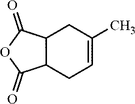 | 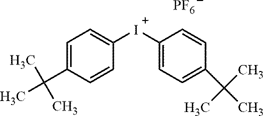 [SMILES: "PF6" ; CC(C)(C)c1ccc([I+]c2ccc(C(C)(C)C)cc2)cc1] |
| (4-methylcyclohex-4-ene-1,2-dicarboxylic anhydride) | |
| UV-visible photosensitizer | Alcohols |
| 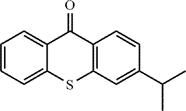 [SMILES: CC(C)c1ccc2c(=O)c3ccccc3sc2c1] | 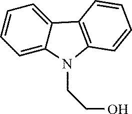 [SMILES: OCCn1c2ccccc2c2ccccc21] |
| 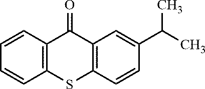 [SMILES: CC(C)c1ccc2sc3ccccc3c(=O)c2c1] | |
| 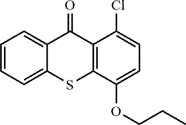 [SMILES: CCCOc1ccc(Cl)c2c(=O)c3ccccc3sc12] | |
| 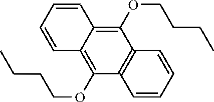 [SMILES: CCCCOc1c2ccccc2c(OCCCC)c2ccccc12] | 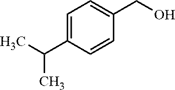 |
| | 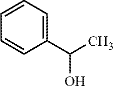 |

All kinetics are performed under the following conditions:
Laser diode @ 405 nm, I = 450 mW / cm²
In thick sample 1.4 mm
Under air

The reagents were used in the following quantities: Epox A (52%) / MCH Anhydride (48%) / photoinitiator (1 wt %) /oxidation agent SC938 (2 wt %)/2 wt% alcohol. Most samples lead to 90-100% epoxide conversion in about 5-10 minutes irradiation with laser diode @405 nm (I=450 mW/cm2), and tackfree polymers were obtained in all cases.

| Photosensitizer | Alcohol | % Epoxide conversion | Tackfree |
|---|---|---|---|
| 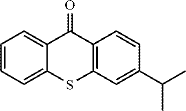 [SMILES: CC(C)c1ccc2c(=O)c3ccccc3sc2c1] | 1-Phenylethanol | 100% | Yes |
| | CARET | 90% | Yes |
| | 4-lsopropylbenzyl alcohol | 82% | Yes |
| | None | 75% | Yes |
| 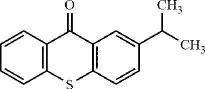 [SMILES: CC(C)c1ccc2sc3ccccc3c(=O)c2c1] | 1-Phenylethanol | 100% | Yes |
| | CARET | 95% | Yes |
| | 4-lsopropylbenzyl alcohol | 90% | Yes |
| | None | 85% | Yes |
| | 1-Phenylethanol | 66% | Yes |
| 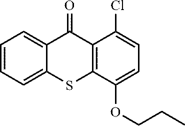 [SMILES: CCCOc1ccc(Cl)c2c(=O)c3ccccc3sc12] | None | 55% | Yes |
| 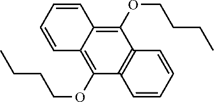 [SMILES: CCCCOc1c2ccccc2c(OCCCC)c2ccccc12] | 1-Phenylethanol | 94% | Yes |
| | CARET | 90% | Yes |
| | None | 87% | Yes |

### Example 5 - Comparative Photochemical System vs. Thermal System

Epoxy-anhydride polyaddition reactions were comparatively carried out with a purely thermal initiator system (no light) vs. the photoinitiator system according to the present invention.

| | | |
|---|---|---|
| Comparative examples (thermal system) | 52% Epox A + 48% MCH anhydride at room temperature (22° C.) | 52% Epox A + 48% MCH anhydride + 2 wt% 1-methyl -1H-imidazole at room temperature (22° C.) |
| Examples according to the present invention (photoinitiator system) | 52% Epox A + 48% MCH anhydride + 1 wt % 2-ITX + 2 wt% lod Laser diode @ 405 nm, I = 450 mW / cm² | 52% Epox A + 48% MCH anhydride + 1 wt % 2-ITX + 2 wt% lod + 2 wt% 1-methyl -1H-imidazole Laser diode @ 405 nm, I = 450 mW / cm² |

In this Example, thermal polyadditions were performed at room temperature (22° C.). Epoxy and anhydride components were mixed. The samples were not cured even after 1h.

FIGS. 5 and 6 show the results, and reveal that the photochemical system according to the invention is much more responsive than the conventional thermal system.

### Example 6 - Comparative Photochemical System of the Invention Vs. Photochemical System Using Iodonium Salt as Photosensitizer

In this Example, the process according to the invention was compared to an epoxy-anhydride photopolyaddition process using an iodonium salt as photosensitizer. Specifically, in this Example is compared the performance of a photoinitiator system according to the invention containing a UV-visible photosensitizer + an iodonium salt vs. a photoinitiator system containing an iodonium salt as photosensitizer.

All kinetics are performed under the following conditions:
Laser diode @ 405 nm, I = 450 mW / cm²
In thick sample 1.4 mm
Under air

The reagents were used in the following quantities: Epox A (52%) / MCH Anhydride (48%) / lod (2 wt %) with or without 2-ITX.

| Composition | % epoxide conversion | Tackfree |
|---|---|---|
| According to the invention Epox A (52%) / MCH Anhydride (48%) / lod (2 wt %)/2-ITX (1 wt%) Laser diode @ 405 nm, I = 450 mW / cm² | 75% | Yes |
| According to the invention Epox A (52%) / MCH Anhydride (48%) / lod (2 wt %)/2-ITX (1 wt%)/1-phenylethanol (2 wt%) Laser diode @ 405 nm, I = 450 mW / cm² | 100% | Yes |
| Comparative composition Epox A (52%) / MCH Anhydride (48%) / lod (2 wt %)Laser diode @ 405 nm, I = 450 mW / cm² | — | Liquid No polymerization |

The samples using a photoinitiator system according to the invention gave tackfree epoxy-anhydride polymers, in the presence of an alcohol or not. However, the photoinitiator system containing only an iodonium salt yielded no polymerization. Cf. FIG. 7.

This demonstrates the remarkable performance of a photoinitiator system according to the invention as compared to an iodonium photosensitizer, under the same conditions.

### Example 7 - Impact of Water Inhibition

In this Example, the impact of water inhibition on the process according to the invention was compared to the impact on an epoxy-anhydride photopolyaddition process using an iodonium salt as photosensitizer, under the same conditions. Specifically, in this Example is compared the performance of a photoinitiator system containing a UV-visible photosensitizer + an iodonium salt vs. a photoinitiator system containing an iodonium salt as photosensitizer, in the presence of water or not.

All kinetics are performed under the following conditions:
Laser diode @ 405 nm, I = 450 mW / cm²
In thick sample 1.4 mm
Under air

The reagents were used in the following quantities: Epox A (52%) / MCH Anhydride (48%) / lod (2 wt %) with or without 2-ITX.

| | | | |
|---|---|---|---|
| Water | Composition | % epoxide conversion | Tackfree |
| No | According to the invention Epox A (52%) / MCH Anhydride (48%) / lod (2 wt %)/2-ITX (1 wt%) Laser diode @ 405 nm, I = 450 mW / cm² | 75% | Yes |
| Yes | According to the invention Epox A (52%) / MCH Anhydride (48%) / lod (2 wt %)/2-ITX (1 wt%)/water (1 wt%) Laser diode @ 405 nm, I = 450 mW / cm² | 60% | Yes |
| Yes | Comparative composition Epox A (52%) / MCH Anhydride (48%) / lod (2 wt %)/water (1 wt%) Laser diode @ 405 nm, I = 450 mW / cm² | - | Liquid No polymerization |

The samples using a photoinitiator system according to the invention gave tackfree epoxy-anhydride polymers, even in the presence of water. However, the photoinitiator system containing only an iodonium salt yielded no polymerization. Cf. FIG. 8.

This demonstrates that a photoinitiator system according to the invention exhibits much better resistance to water inhibition than an iodonium photosensitizer.

### Example 8 - Impact of Oxygen Inhibition

In this Example, the impact of oxygen inhibition on the process according to the invention was assessed, and epoxide conversion vs time performance of a photoinitiator system according to the present invention in the presence of oxygen (air) vs. laminate conditions (oxygen-free) were compared.

All kinetics are performed under the following conditions:
Laser diode @ 405 nm, I = 450 mW / cm²
In thick sample 1.4 mm
Under air or under laminate conditions

The reagents were used in the following quantities: Epox A (52%) / MCH Anhydride (48%) / lod (2 wt %) / 2-ITX (2 wt %), under air or under laminate conditions (no air).

| Air/oxygen | % epoxide conversion | Tackfree |
|---|---|---|
| No (laminate conditions) | 50% | Yes |
| Yes | 75% | Yes |

The samples gave tackfree epoxy-anhydride polymers, even in the presence of air (oxygen). Cf. FIG. 9.

This demonstrates that there is no oxygen inhibition when a photoinitiator system according to the invention is used in the photopolyaddition of epoxy-anhydride resins.

Mechanical properties and Tg’s were assessed (FIGS. 10-14), and the results show the remarkable advantage of a photoinitiating composition according to the present invention for preparing epoxy-anhydride resins. The results are compiled in the table below:

| | | | |
|---|---|---|---|
| | Photoinitiator according to the invention 52% Epox A + 48% MCH anhydride + 1 wt%2-ITX+2 wt% lod With or without 2 wt% 1-phenylethanol | Comparative photoinitiator lod only 52% Epox A + 48% MCH anhydride + +2 wt% lod | Comparative purely thermal system 52% Epox A + 48% MCH anhydride |
| Time for polymerization (sec.) | Polymerization after 300 sec. @ room temperature with LD@405 nm | No polymerization after 600 sec. @ room temperature with LD@405 nm | No polymerization after 3 hours @ room temperature No polymerization after 1 h @50° C. No polymerization after 600 sec. @room temperature with LD@405 nm |
| Glass transition temperature Tg (°C) | 40-50° C., with or without alcohol (1-phenylethanol) | Not measurable | Not measurable |

### Example 9 - Photopolyaddition of Epoxy-Anhydride Resins in the Near-Infrared in the Presence of an Imidazole Accelerator

The epoxy-anhydride photopolyaddition according to the invention was carried out using the following components:

Epoxide component

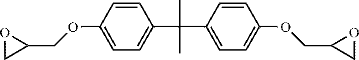 [SMILES: CC(C)(c1ccc(OCC2CO2)cc1)c1ccc(OCC2CO2)cc1]

| Anhydride component | Imidazole accelerator |
|---|---|
| 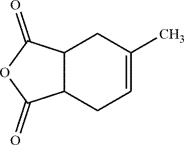 | 1-methyl -1H-imidazole |
| (4-methylcyclohex-4-ene-1,2-dicarboxylic anhydride) | |
| NIR photosensitizer | |
| 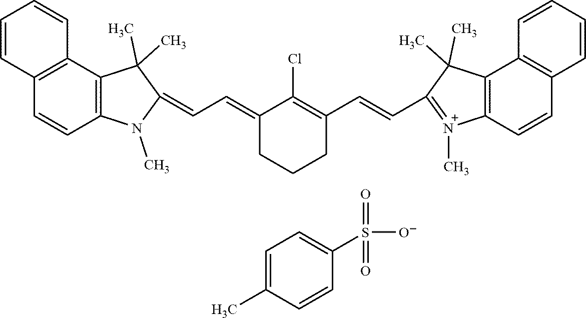 [SMILES: CN1/C(=C/C=C2\CCCC(/C=C/C3=[N+](C)c4ccc5ccccc5c4C3(C)C)=C2Cl)C(C)(C)c2c1ccc1ccccc21 ; Cc1ccc(S(=O)(=O)[O-])cc1] | |

The kinetics were carried out under the following conditions:
Laser diode @ 785 nm, I = 2.5 W / cm²
In thick sample 1.4 mm
Under air

The reagents were used in the following quantities: Epox A (52%) / MCH Anhydride (48%) / IR-813-p-toluenesulfonate (0.1 wt%) / imidazole accelerator (2 wt %). All samples lead to 100% epoxide conversion after less than 100 sec irradiation with laser diode @785 nm (1=2.5 W/cm2), and tackfree polymers were obtained in all cases.

This was compared to the same photopolyaddition reaction under the following conditions:
Epox A (52%) / MCH Anhydride (48%) / IR-813-p-toluenesulfonate (0.1 wt%) / imidazole accelerator (2 wt%) / lod (2 wt%) -> FIG. 15 (ii)
Epox A (52%) / MCH Anhydride (48%) / IR-813-p-toluenesulfonate (0.1 wt%) / lod (2 wt%) -> FIG. 15 (iv)
Epox A (52%) / MCH Anhydride (48%) / IR-813-p-toluenesulfonate (0.1 wt%) -> FIG. 15 (iii)

The comparative results shown in FIG. 15 reveal the excellent performance of the combination NIR dye IR-813 + imidazole accelerator according to the invention, even in the absence of an iodonium photosensitizer.

### Example 10 - Bonding Tests

Two bands of adhesive tape (from Taconic) were placed 10 mm apart across an epoxy plate (thickness 2 mm, Epoxy GF Vetront EGS 619) as shown on FIG. 16A. A mixture Epox A (52%) / MCH Anhydride (48%) / 2-ITX (1 wt%) /oxidation agent SC938 / 2 wt% 1-phenylethanol (2 wt%) was prepared and evenly enducted between the two adhesive bands on the epoxy plate, thereby ensuring a mixture coating of about 0.1-0.2 mm. A second epoxy plate was superimposed on the first epoxy plate, so that the enducted composition was sandwiched between the epoxy plates (cf. FIG. 16A). The adhesive tape bands allowed to maintain a homogeneous thickness. The assembly was subjected to UV-visible irradiation (Laser diode @ 405 nm, I = 450 mW / cm²) for 30 sec., 1 min., 2 min., 5 min. or 10 min (cf. FIG. 16B).

This allowed bonding of the superimposed epoxy plates. The samples irradiated for 5 and 10 minutes led to strong bonding of the epoxy plate (the plates could not be separated/delaminated). The mechanical stress increased with increased irradiation time.

### Example 11 - Composites

### Example 11.1

The photoinitiating system, composed of SC938 (2 wt%) and G1 (0.5 wt%), was first dissolved in 0.9±0.02 g MCH Anhydride at room temperature, the wt% being calculated based on the total weight epoxy/anhydride. The resulting mixture was mixed with about 1.00±0.03 g Epoxy A at room temperature during about 45 sec before starting the experiment. The resulting mixture (50%) was enducted on a fiberglass sheet (50%) (i.e., weight ratio reaction mixture/fiberglass sheet 50/50). The enducted fiberglass support was then passed through a Hamamatsu conveyor belt under laser diode irradiation @405 nm (I=12 W/cm2), with a speed of 2 m/min. The top surface of the sample was tackfree after 3 passes, and the bottom surface was tackfree after 10 passes. The final composite had a thickness of 0.761 mm.

The same experiment was repeated using 2 fiberglass sheets (weight ratio reaction mixture/fiberglass sheets 50/50). FIG. 16. The top surface of the sample was tackfree after 2 passes, and the bottom surface was still tacky after 10 passes. The sample was flipped over and the bottom surface was irradiated and was tackfree after 2 passes. The final composite had a thickness of 0.800 mm.

The same experiment was repeated using 4 fiberglass sheets (weight ratio reaction mixture/fiberglass sheets 50/50). FIG. 16. The top surface of the sample was tackfree after 2 passes, and the bottom surface was still tacky after 10 passes. The sample was flipped over and the bottom surface was irradiated and was tackfree after 3 passes. The final composite had a thickness of 2.468 mm.

### Example 11.2

The photoinitiating system, composed of SC938 (2 wt%) and ITX (1 wt%), was first dissolved in 0.9±0.02 g MCH Anhydride at room temperature, together with 4-isopropylbenzyl alcohol (2 wt%), the wt% being calculated based on the total weight epoxy/anhydride. The resulting mixture was mixed with about 1.00±0.03 g Epoxy A at room temperature during about 45 sec before starting the experiment. The resulting mixture (50%) was enducted on a fiberglass sheet (50%) (i.e., weight ratio reaction mixture/fiberglass sheet 50/50). The enducted fiberglass support was then passed through a Hamamatsu conveyor belt under laser diode irradiation @405 nm (I=12 W/cm2), with a speed of 2 m/min. The top surface of the sample was tackfree after 4 passes, and the bottom surface was still tacky after 10 passes. The sample was flipped over and the bottom surface was irradiated and was tackfree after 4 passes. The final composite had a thickness of 0.768 mm.

The same experiment was repeated using 1 carbon fiber sheet (weight ratio reaction mixture/fiberglass sheet 50/50). The top surface of the sample was tackfree after 4 passes, and the bottom surface was still tacky after 10 passes. The sample was flipped over and the bottom surface was irradiated and was tackfree after 4 passes.

### Example 11.3

The photoinitiating system, composed of SC938 (2 wt%) and G1 (0.5 wt%), was first dissolved in 0.9±0.02 g MCH Anhydride at room temperature, together with 1-phenylethanol (2 wt%), the wt% being calculated based on the total weight epoxy/anhydride. The resulting mixture was mixed with about 1.00±0.03 g Epoxy A at room temperature during about 45 sec before starting the experiment. The resulting mixture (50%) was enducted on a carbon fiber sheet (50%) (weight ratio reaction mixture/carbon fiber sheet 50/50). The enducted fiberglass support was then passed through a Hamamatsu conveyor belt under laser diode irradiation @405 nm (I=12 W/cm2), with a speed of 2 m/min. The top surface of the sample was tackfree after 2 passes, and the bottom surface was still tacky after 10 passes. The sample was flipped over and the bottom surface was irradiated and was tackfree after 2 passes.

### Example 12 - Comparative Example

Epoxide component

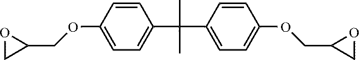 [SMILES: CC(C)(c1ccc(OCC2CO2)cc1)c1ccc(OCC2CO2)cc1]

| | |
|---|---|
| Anhydride component | Photoinitiator |
| 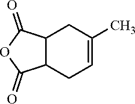 | 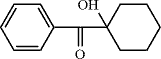 [SMILES: O=C(c1ccccc1)C1(O)CCCCC1] |
| (4-methylcyclohex-4-ene-1,2-dicarboxylic anhydride) | |

The epoxy-anhydride photopolyaddition was carried out using the following components: Epox A (52 wt%) / MCH Anhydride (48 wt%) / Irgacure 184 (2 wt%) with irradiation at the appropriate wavelength for Irgacure 184 and it has been noted that polymerisation was not obtained: after the irradiation, the mixture remained liquid (FIG. 18).

### Conclusions

The Examples that precede illustrate the reduction to practice of enhanced/improved cyclic ether-anhydride photopolyaddition, which marks a significant leap forward in light induced production of materials. Its potential in the industry is huge as it allows spectacular kinetics enhancements and improved mechanical properties for cyclic ether/anhydride resins, such as epoxy/anhydride resins. Even more interestingly, cyclic ether-anhydride photopolyaddition already shows a huge versatility from thin to thick samples and is compatible with composites production. Remarkably, this is the very first report of imidazole catalysis/acceleration to outstandingly enhance reaction epoxy-anhydride kinetics upon safe irradiation conditions (@405 nm). The addition of benzyl-type alcohol additives proved to be particularly useful in enhancing the efficacy of the photopolyaddition process.

While we have described a number of embodiments of this invention, it is apparent that the Examples may be altered to provide other embodiments that utilize the compositions and methods of this invention. Therefore, it will be appreciated that the scope of this invention is to be defined by the appended claims rather than by the specific embodiments that have been represented herein by way of example.

### REFERENCES

“Handbook of Epoxy Resins,” Lee & Neville, Mc Graw-Hill (1982), “Chemistry and technology of the epoxy Resins,” B. Ellis, Chapman Hall (1993), New York and “Epoxy Resins Chemistry and technology,” C. A. May, Marcel Dekker, New York (1988).

IUPAC. Compendium of Chemical Terminology, 2nd ed. (the “Gold Book”). 6. Yilmaz, G., Beyazit, S. & Yagci, Y. Visible light induced free radical promoted cationic polymerization using thioxanthone derivatives. J. Polym. Sci. Part Polym. Chem. 49, 1591-1596 (2011).

a) Ajayaghosh, A. Chemistry of Squaraine-Derived Materials: Near-IR Dyes, Low Band Gap Systems, and b) Cation Sensors. Acc. Chem. Res. 2005, 38, 449-459.

Bures, F. Fundamental aspects of property tuning in push-pull molecules. RSC Adv. 2014, 4, 58826-58851.

Alfred Treibs und Franz-Heinrich Kreuzer. Difluorboryl-Komplexe von Di- und Tripyrrylmethenen. Justus Liebigs Annalen der Chemie 1968, 718 (1): 208-223; BODIPY Dye Series Archived 2008-02-26 at the Wayback Machine.

K. L. Marshall, G. Painter, K. Lotito, A. G. Noto & P. Chang (2006) Transition Metal Dithiolene Near-IR Dyes and Their Applications in Liquid Crystal Devices, Molecular Crystals and Liquid Crystals, 454:1, 47/[449]-79/[481].

WO 94/22968

EP0276501A1

EP0249201A1

WO 97/12945

EP0008127A1

Garra, P. , Bonardi, A. , Baralle, A. , Al Mousawi, A. , Bonardi, F. , Dietlin, C. , Morlet-Savary, F. , Fouassier, J. and Lalevee, J., Monitoring photopolymerization reactions through thermal imaging: A unique tool for the real-time follow-up of thick samples, 3D printing, and composites. J. Polym. Sci. Part A: Polym. Chem., 2018, 56: 889-899.

Dahlen, M. A. The Phthalocyanines A New Class of Synthetic Pigments and Dyes. Ind. Eng. Chem. 1939, 31 (7), 839-847.

Torre, G. de la; Claessens, C. G.; Torres, T. Phthalocyanines: Old Dyes, New Materials. Putting Color in Nanotechnology. Chem. Commun. 2007, 0 (20), 2000-2015.

Dietlin, C. et al. Photopolymerization upon LEDs: new photoinitiating systems and strategies. Polym. Chem. 6, 3895-3912 (2015).

1. A composition curable on demand under the triggering action of UV-visible to near-infrared irradiation comprising:
(a) at least one polyfunctional cyclic ether component comprising at least two cyclic ether moieties;
(b) at least one carboxylic anhydride component comprising at least one carboxylic anhydride moiety; and
(c) a photoinitiating system generating catalytic species comprising at least one suitable photoinitiator or photosensitizer that absorbs light at the desired UV-visible to near-infrared irradiation under which the composition is to be cured; and (i) at least one oxidation agent able to react with the photoinitiator or the photosensitizer, selected from iodonium salts, sulfonium salts, peroxides and thianthrenium salts; and/or (ii) at least one accelerator of epoxy-anhydride polyaddition processes selected from imidazoles.

2. A composition according to claim 1, wherein at least one polyfunctional cyclic ether component is selected from aliphatic, heteroaliphatic, aromatic or heteroaromatic polyfunctional epoxy compounds;
for example the cyclic ether component is selected from:
polyfunctional aromatic epoxy compounds such as: 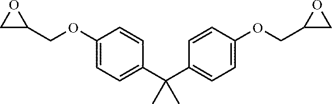 [SMILES: CC(C)(c1ccc(OCC2CO2)cc1)c1ccc(OCC2CO2)cc1] 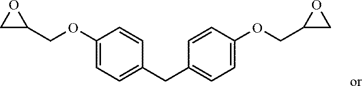 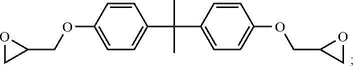
polyfunctional heteroaliphatic epoxy compounds such as: 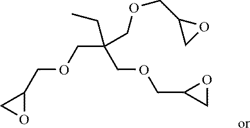 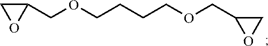
epoxy prepolymers obtained from reaction of diols with epichlorhydrine, such as bisphenol A diglycidyl ether, 1,4-butanediol diglycidyl ether;
epoxy prepolymers obtained from reaction of diamines with epichlorhydrine, such as 4,4′-diaminodiphenyl methane tetraglycidyl ether;
or a mixture of two or more of the above.

3. A composition according to claim 1 or 2, wherein at least one carboxylic anhydride component is selected from heteroaliphatic, aromatic or heteroaromatic compounds comprising at least one —C(═O)—O—C(═O)— group; such as one or more anhydrides selected from:
(i) (iso)phthalic-type anhydrides such as 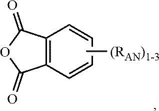 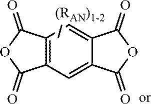 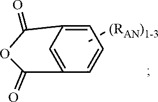
wherein each occurrence of R_{AN} independently represents H, halogen or C1-6alkyl; preferably H or C1-6alkyl; for example H, methyl or ethyl;
(ii) polyhydrophthalic-type anhydrides such as 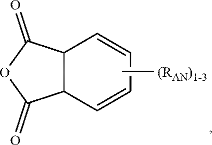 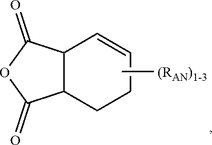 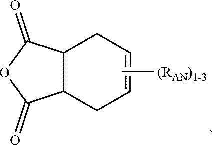 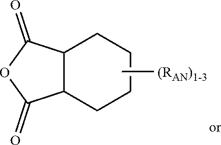 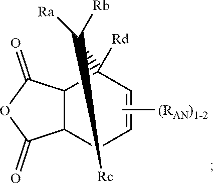
wherein each occurrence of R_{AN} independently represents H, halogen or C1-6alkyl; preferably H or C1-6alkyl; for example H, methyl or ethyl; and Ra, Rb, Rc and Rd independently represent H or halogen, for example H or Cl;
(iii) Maleic or succinic-type anhydrides such as 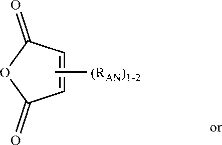 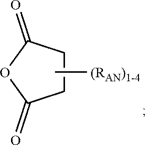
wherein each occurrence of R_{AN} independently represents H, halogen or linear or branched C1-20alkyl; for example H, chloro, methyl, ethyl, n-butyl, n-octadecyl or n-dodecyl;
(iv) aliphatic-type polyanhydrides such as 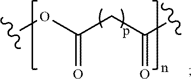
wherein p is an interger from 2 to 6, and n represents the number of monomer units in the polymer; for example, n may range from 10 to 100.

4. A composition according to any one of claims 1-3, wherein at least one suitable photoinitiator or photosensitizer is selected from
photoinitiators or photosensitizers in the UV, near-UV and Visible:
type I photoinitiators such as 2-hydroxy-2-methyl-1-phenylpropan-1-one, 2-hydroxy-1,2-diphenhylethanone, (diphenylphosphoryl)(phenyl)methanone, 2-(dimethylamino)-1-(4-morpholinophenyl)ethanone, bis-acylphosphine oxide (BAPO), (diphenylphosphoryl)(mesityl)methanone, Ethyl (2,4,6-trimethylbenzoyl) phenyl phosphinate, bis(η5-2,4-cylcopentadien-1-yl)-bis(2,6-difluoro-3-(1H-pyrrol-1-yl)-phenyl) titanium, 2,2-Dimethoxy-1,2-diphenylethan-1-one, 2-Methyl-4′-(methylthio)-2-morpholinopropiophenone;
type II photoinitiators such as benzophenone, xanthones, thioxanthones such as ITX, 2-ITX and CPTX, quinones, anthraquinones, and camphorquinone; 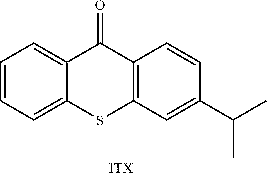 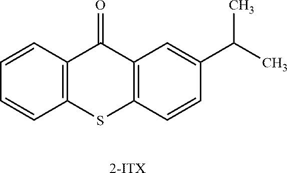 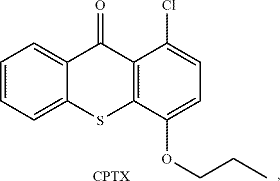
organic dye photosensitizers such as eosin Y and Rose Bengal; 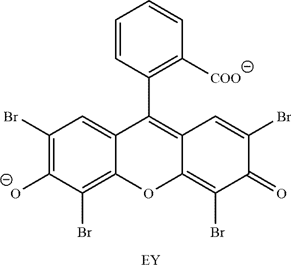 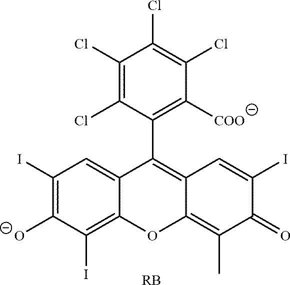
polyaromatic hydrocarbon photosensitizers such as pyrene and anthracene;
preferably camphorquinone or thioxanthone compounds such as ITX, 2-ITX and CPTX;
photoinitiator or photosensitizer in the red to Near infrared such as a suitable dye that generates heat when exposed to a 625-2500 nm light source, for example when exposed to a 625-1500 nm light irradiation; for example a heat-generating dye selected from:
(i) cyanine dyes;
(ii) squaraine and squarylium dyes;
(iii) push-pull compounds;
(iv) BODIPY and pyrromethene dyes;
(v) Dithiolene metal salt dyes;
(vi) Porphyrin dyes;
(vii) Copper complex dyes;
(viii) Phthalocyanine dyes;
or a mixture of one or more of the above;
for example any one or more of the following: 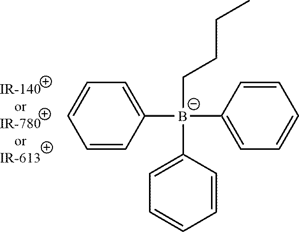 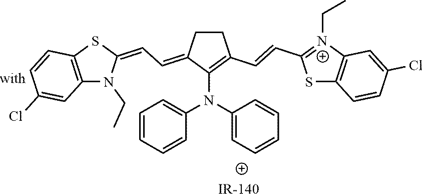 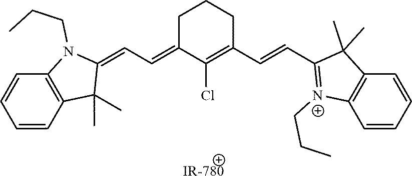 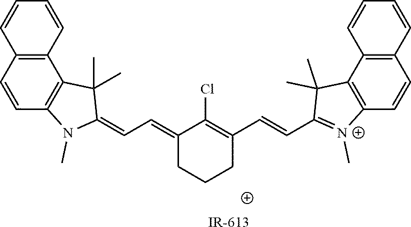 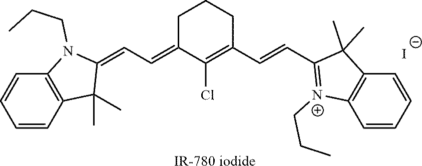 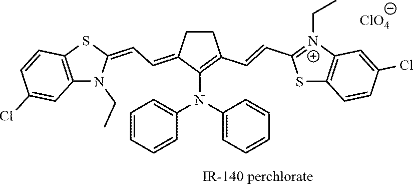 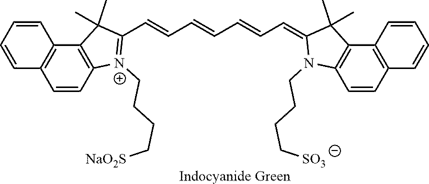 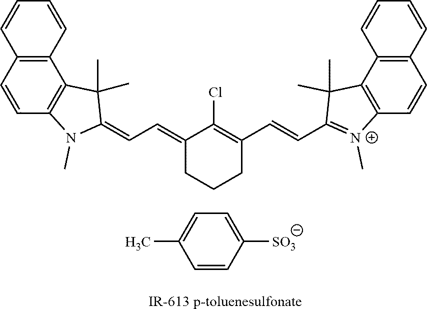 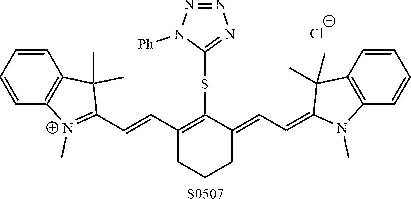 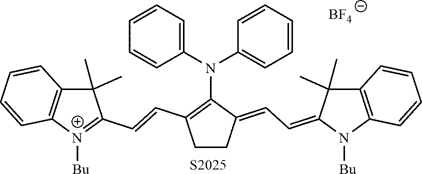 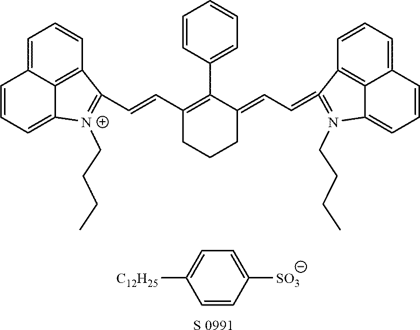 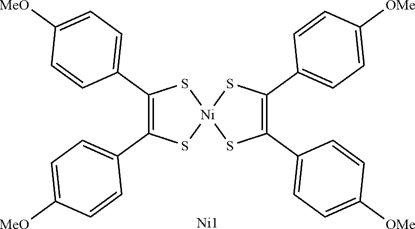 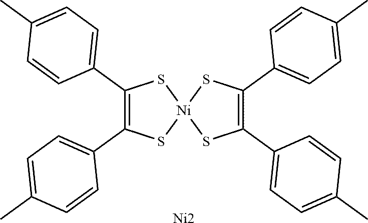 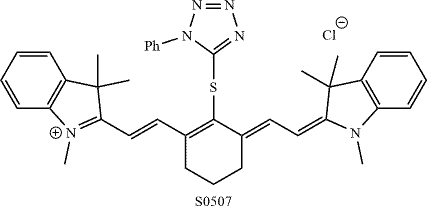 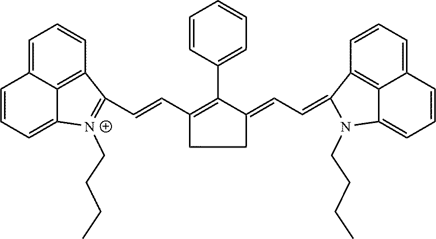 [SMILES: CCCCn1/c(=C/C=C2\CCC(/C=C/C3=[N+](CCCC)c4cccc5cccc3c45)=C2c2ccccc2)c2cccc3cccc1c32] 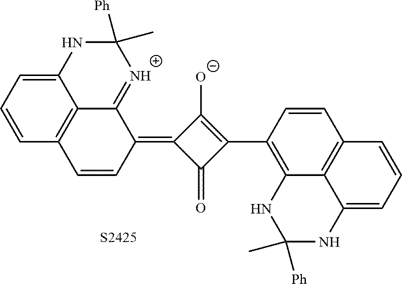 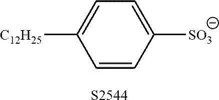 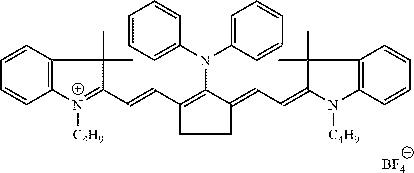 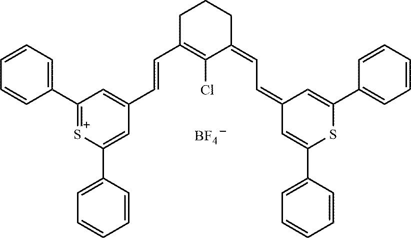 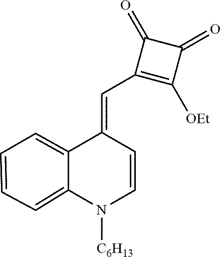 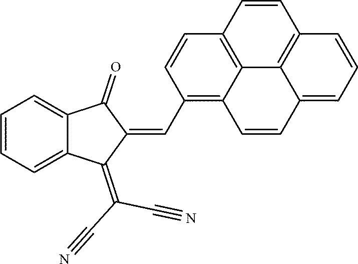 [SMILES: N#CC(C#N)=C1/C(=C/c2ccc3ccc4cccc5ccc2c3c45)C(=O)c2ccccc21] 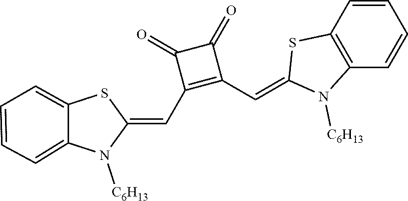 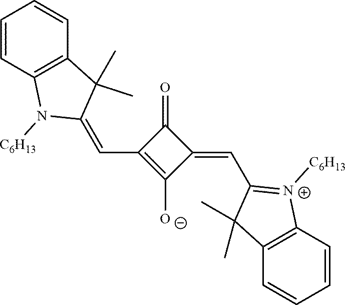 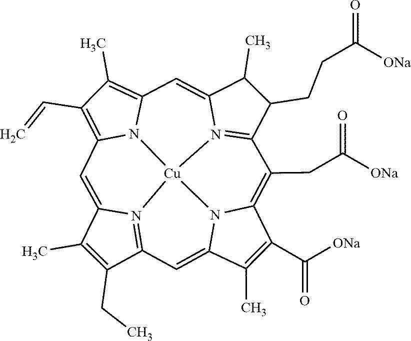 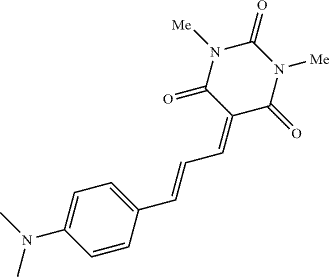 [SMILES: CN1C(=O)C(=C/C=C/c2ccc(N(C)C)cc2)C(=O)N(C)C1=O] 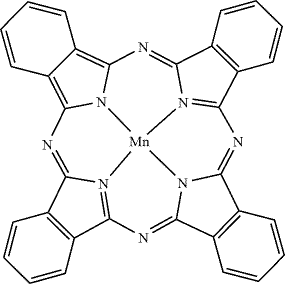 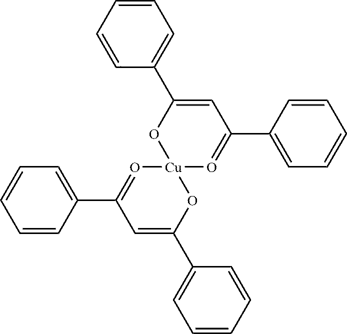 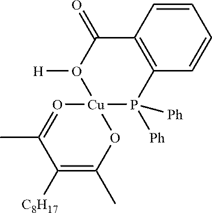 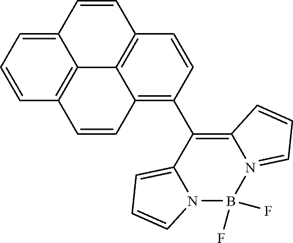
.

5. A composition according to any one of claims 1-4, wherein at least one oxidation agent is selected from:
onium salts such as iodonium salts of formula ((R_{A})₂I⁺X_{A}⁻ or such as sulfonium or thianthrenium salts of formula (R_{B})₃S⁺X_{A}⁻; wherein each occurrence of R_{A} and R_{B} independently represents a C₆₋₁₀ aryl or a C₁₋₁₀ alkyl moiety; wherein the aryl moiety may be, individually, further substituted with one or more linear or branched C₁₋₆ alkyl, —OC₁₋₆ alkyl, —SC₁₋ ₆ alkyl moieties, or C₆₋₁₀ aryl, —OC₆₋₁₀ aryl, —SC₆₋₁₀ aryl, —C(═O)C₆₋₁₀ aryl moieties; wherein two adjacent radicals R_{B} together with the S atom to which they are attached may form a 6-membered heterocyclic moiety; and wherein X_{A}⁻ represents a suitable counter ion such as B(PhF₆)₄⁻, AsF₆⁻; PF₆⁻, SbF₆⁻ or Cl⁻; preferably: 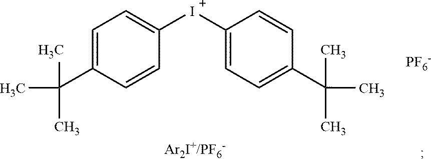 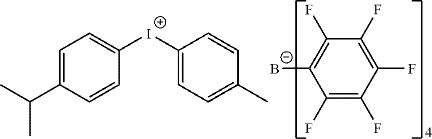 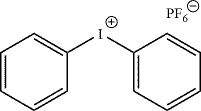 [SMILES: c1ccc([I+]c2ccccc2)cc1 ; "PF6"] 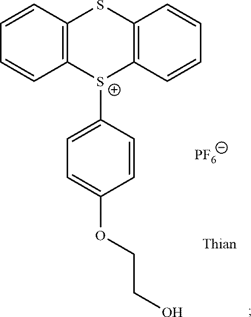 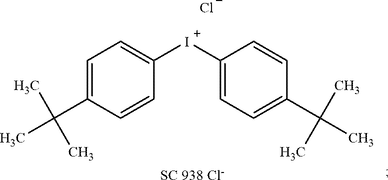 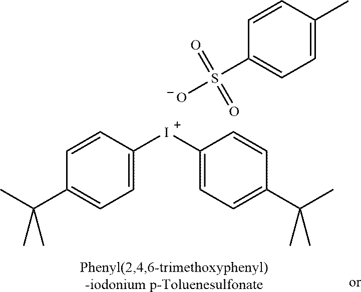 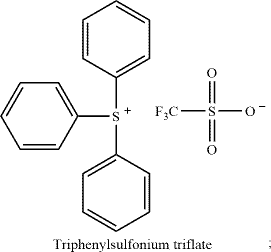
peroxides selected from dibenzoyl peroxide, lauroyl peroxide, dicumyl peroxide, di-tert-butyl peroxide, cumyl hydroperoxide, tert-butyl perbenzoate, cyclohexanone peroxide, methyl ethyl ketone hydroperoxide, acetylacetone peroxide, tert-butyl peroctoate, bis-2-ethylhexyl peroxide dicarbonate or tert-butyl peracetate, and 2-butanone peroxide; preferably dibenzoyl peroxide.

6. A composition according to any one of claims 1-5, further comprising an imidazole-type accelerator of epoxy-anhydride polyaddition processes, such as: 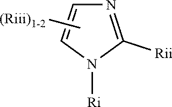
wherein
Ri represents H, C1-6alkyl, C6-10arylC1-6alkyl, or C6-10heteroarylC1-6alkyl;
Rii represents H, C1-20alkyl, C6-10aryl; and
each occurrence of Riii independently represents H, or C1-6alkyl;
wherein each of the foregoing alkyl, aryl and heteroayl moieties may bear one or more substituents selected from halogen, CN or OH;
for example, imidazole-type accelerators having the structure: 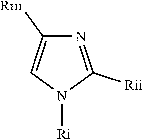
wherein Ri represents H, C1-6alkyl, C6-10arylC1-6alkyl, or C6-10heteroarylC1-6alkyl; preferably H, methyl, benzyl or 1,3,5-triazine-2,4-diamine-ethyl;
Rii represents H, C1-20alkyl, or C6-10aryl; preferably H, C1-6alkyl, C15-20alkyl, or phenyl; more preferably H, methyl, ethyl, C17alkyl, or phenyl; and each occurrence of Riii independently represents H, or optionally substituted C1-6alkyl; preferably H, methyl or —CH₂OH;
preferably from any one or more of:

| | | |
|---|---|---|
| 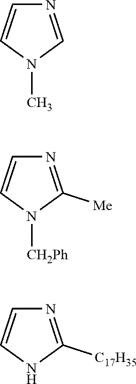 | 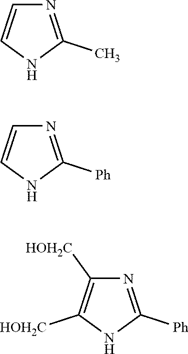 | 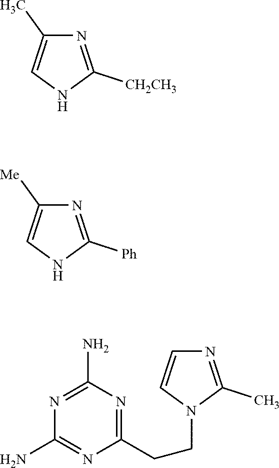 |

preferably 1-methyl -1H-imidazole.

7. A composition according to any one of claims 1-6, further comprising a benzyl-type alcohol, such as: 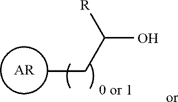 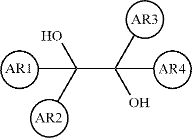
wherein AR, AR1, AR2, AR3 and AR4 independently represent an optionally substituted C6-C10 aryl or heteroaryl moiety (substituents may include halogen, linear or branched C1-6alkyl or linear or branched C1-6heteroalkyl); and R represents H, linear or branched C1-6alkyl; preferably R represents H or methyl;
for example: 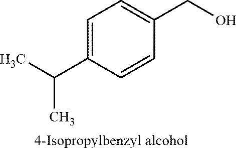 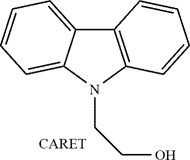 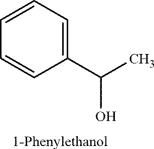 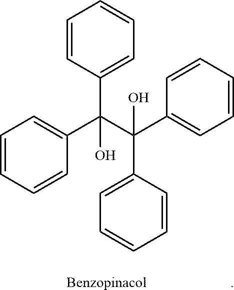
.

8. Use of a photoinitiator or photosensitizer in combination with an oxidation agent selected from iodonium salts, sulfonium salts, peroxides and thianthrenium salts, for accelerated photopolyaddition of cyclic ether-anhydride resins under UV-visible to near-infrared irradiation.

9. Use of a photoinitiator or photosensitizer in combination with an oxidation agent selected from iodonium salts, sulfonium salts, peroxides and thianthrenium salts, for dark curing cyclic ether-anhydride resins under UV-visible to near-infrared irradiation.

10. A process for accelerated curing of a cyclic ether-anhydride resin comprising the step of exposing to a UV-visible to near-infrared irradiation a composition comprising:
at least one polyfunctional cyclic ether component comprising at least two cyclic ether moieties; and
at least carboxylic anhydride component comprising at least one carboxylic anhydride moiety;
in the presence of a photoinitiating system generating catalytic species comprising at least one suitable photoinitiator or photosensitizer that absorbs light at the desired UV-visible to near-infrared irradiation under which the composition is to be cured; and (i) at least one oxidation agent able to react with the photoinitiator or the photosensitizer, selected from iodonium salts, sulfonium salts, peroxides and thianthrenium salts; and/or (ii) at least one accelerator of epoxy-anhydride polyaddition processes selected from imidazoles, such as: 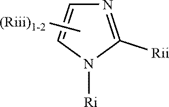
wherein
Ri represents H, C1-6alkyl, C6-10arylC1-6alkyl, or C6-10heteroarylC1-6alkyl;
Rii represents H, C1-20alkyl, C6-10aryl; and
each occurrence of Riii independently represents H, or C1-6alkyl;
wherein each of the foregoing alkyl, aryl and heteroayl moieties may bear one or more substituents selected from halogen, CN or OH;
for example, imidazole-type accelerators having the structure: 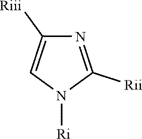
wherein Ri represents H, C1-6alkyl, C6-10arylC1-6alkyl, or C6-10heteroarylC1-6alkyl; preferably H, methyl, benzyl or 1,3,5-triazine-2,4-diamine-ethyl;
Rii represents H, C1-20alkyl, or C6-10aryl; preferably H, C1-6alkyl, C15-20alkyl, or phenyl; more preferably H, methyl, ethyl, C17alkyl, or phenyl; and
each occurrence of Riii independently represents H, or optionally substituted C1-6alkyl; preferably H, methyl or —CH₂OH ;
preferably from any one or more of:

| | | |
|---|---|---|
| 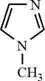 | 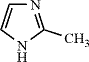 | 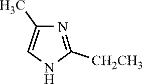 |
| 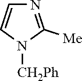 | 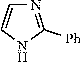 [SMILES: c1ccc(-c2ncc[nH]2)cc1] | 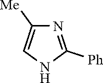 [SMILES: Cc1c[nH]c(-c2ccccc2)n1] |
| 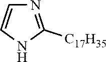 | 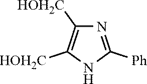 [SMILES: OCc1nc(-c2ccccc2)[nH]c1CO] | 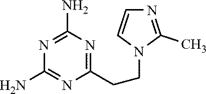 [SMILES: Cc1nccn1CCc1nc(N)nc(N)n1] |

preferably 1-methyl -1H-imidazole;
optionally in the presence of a benzyl-type alcohol, such as: 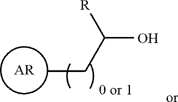 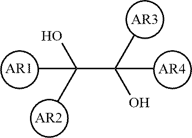
wherein AR, AR1, AR2, AR3 and AR4 independently represent an optionally substituted C6-C10 aryl or heteroaryl moiety (substituents may include halogen, linear or branched C1-6alkyl or linear or branched C1-6heteroalkyl); and R represents H, linear or branched C1-6alkyl; preferably R represents H or methyl;
for example: 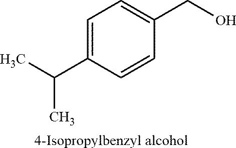 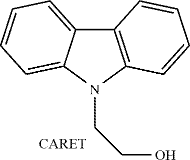 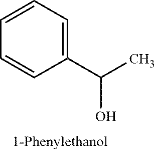 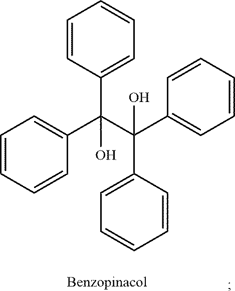
wherein the polyfunctional cyclic ether component, the anhydride component, the photoinitiator and the photosensible oxidation agent are as defined in any one of claims 1 to 6.

11. A process according to claim 10, wherein the irradiation intensity is 25 mW/cm² ≤ I ≤ 100 W/cm².

12. A process according to claim 10 or 11, wherein the duration of exposure of the resin to UV-visible to near-infrared irradiation is 1 to 800 seconds, preferably between 1 and 300 seconds, more preferably between 1 and 150 seconds.

13. A process according to any one of claims 10 to 12, further comprising a step of mixing or impregnating composite reinforcements with said composition prior to UV, Visible, to near-infrared irradiation.

14. A process according to claim 13, wherein the composite reinforcements are glass fibers, carbon fibers, aramid fibers, basalt fibers, silica fibers, polymer fibers, natural fibers or a mixture of two or more of those.

15. A process according to any one of claims 10 to 14, wherein crosslinking/curing of the composition occurs throughout the whole thickness of the composition.

16. A process according to any one of claims 10 to 15, which may be carried out under air.

17. A resin casting, film or coated substrate comprising a cyclic ether-anhydride resin obtained by an accelerated curing process according to any one of claims 10 to 16.

18. The coated substrate of claim 17, wherein the substrate includes metal, glass, ceramic, plastic, adhesive, polymer, composite or wood.

19. An adhesive layer or bonding agent comprising a cyclic ether-anhydride resin obtained by an accelerated curing process according to any one of claims 10 to 16.

20. A composite comprising (i) a cyclic ether-anhydride resin obtained by an accelerated curing process according to any one of claims 10 to 16, and (ii) a reinforcing agent.

21. A process for forming the composite of claim 20, said process comprising spraying, coating or applying a composition according to any one of claims 1-7 onto a substrate and subsequently curing said composition under UV-visible to near-infrared irradiation.

22. Use of a composition of any one of claims 1 to 7, for increasing the delamination strength of laminated composite materials.

23. Use of an alcohol comprising an —OH group on a carbon atom α or β to an aromatic or heteroaromatic nucleus for enhancing a curing process of a cyclic ether-anhydride resin according to any one of claims 10 to 16.

24. Use of a compound comprising an N-substituted imidazole ring for enhancing a curing process of a cyclic ether-anhydride resin according to any one of claims 10 to 16.
